(19) United States
(12) Patent Application Publication
(10) Pub. No.: US 2026/0230909 A1
(43) Pub. Date: Aug. 6, 2026

(54) Method and Apparatus for Session Management

(71) Applicant: Telefonaktiebolaget LM Ericsson (publ), Stockholm (SE)

(72) Inventors: Chunmiao Liu, Shanghai (CN); Wen Zhang, Shanghai (CN); Yongdi Gu, Shanghai (CN); Yunjie Lu, Shanghai (CN); Zhansheng Wei, Shanghai (CN); Yingjiao He, Shanghai (CN)

(21) Appl. No.: 19/149,974

(22) PCT Filed: Feb. 5, 2024
(86) PCT No.: PCT/CN2024/075992

§ 371 Date: Jul. 22, 2025

(30) Foreign Application Priority Data
Feb. 14, 2023 (WO) PCT/CN2023/075965

(51) Int. Cl. H04W 28/02

(52) U.S. Cl. CPC H04W 28/0268

(57) ABSTRACT

Embodiments of the present disclosure provide method and apparatus for session management. A method performed by a first session management function (SMF) comprises sending a first message to a second SMF. The first message comprises a quality of service (QoS) flows setup list comprising one or more QoS flows to establish for a protocol data unit (PDU) session. The method further comprises receiving a second message comprising information of at least one QoS flow failed to be established from the second SMF. The information of at least one QoS flow failed to be established indicates that updating the at least one QoS flow failed to be established to a terminal device is not needed and/or releasing the at least one QoS flow failed to be established to the terminal device is not needed and/or the at least one QoS flow failed to be established is rejected by the second SMF.

### PRIORITY CLAIM

This application claims the priority of a PCT application with International Application No. PCT/CN2023/075965 and International Filing Date Feb. 14, 2023.

### TECHNICAL FIELD

The non-limiting and exemplary embodiments of the present disclosure generally relate to the technical field of communications, and specifically to methods and apparatuses for session management.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks, there may be various sessions such as protocol data unit (PDU) sessions. For example, a user equipment (UE) may request PDU session establishment for home-routed roaming scenarios. A UE or a network may request PDU session modification for home-routed roaming scenarios.

3GPP TS 23.502 V18.0.0, the disclosure of which is incorporated by reference herein in its entirety, has specified that a visited session management function (V-SMF) and/or a radio access network (RAN) may reject a part of quality of service (QoS) flows due to constraints and a home session management function (H-SMF) is responsible for update to the UE on the failed QoS flows.

FIG. 1a shows a flowchart of UE-requested PDU session establishment for home-routed roaming scenarios, which is same as FIG. 4.3.2.2.2-1 of 3GPP TS 23.502 V18.0.0. The following steps 13 and 23 have been described in clause 4.3.2.2.2 of 3GPP TS 23.502 V18.0.0 as bellow.

13: The V-SMF may apply VPLMN policies related with the SLA negotiated with the HPLMN or with QoS values supported by the VPLMN to evaluate the QoS parameters received from H-SMF; such policies may result in that V-SMF does not accept the PDU Session or does not accept some of the QoS Flows requested by the H-SMF. If the V-SMF does not accept the PDU Session, the V-SMF triggers the V-SMF initiated PDU Session Release procedure from step 1b-3b as defined in clause 4.3.4.3. When the V-SMF accepts at least one QoS flow, it transfers (via the AMF) the corresponding N2 (and NAS) request towards the 5G AN (and the UE) but does not issue requests for the QoS Flow(s) it has rejected due these policies. The V-SMF notifies the H-SMF about the rejected QoS Flows in step 23 below.

23. If the V-SMF received in step18 an indication that the (R)AN has rejected some QFI(s) or if the V-SMF has rejected some QFI(s) in step 13, the V-SMF notifies the H-SMF via a Nsmf_PDUSession_Update Request. The H-SMF is responsible of updating accordingly the QoS rules and OoS Flow level OoS parameters if needed for the QoS Flow(s) associated with the QoS rule(s) in the UE.

For other steps of FIG. 1a that have been described in clause 4.3.2.2.2 of 3GPP TS 23.502 V18.0.0, the description thereof is omitted here for brevity.

FIG. 1b shows a flowchart of UE or network requested PDU session modification for home-routed roaming scenario, which is same as FIG. 4.3.3.3-1 of 3GPP TS 23.502 V18.0.0.

The following steps 3 and 15 have been described in clause 4.3.3.3 of 3GPP TS 23.502 V18.0.0 as bellow.

3. (UE or serving network requested or HPLMN requested) The H-SMF invokes the Nsmf_PDUSession_Update Request (SM Context ID, QoS profiles, [Alternative QoS profile(s)], Session-AMBR, information needed to build the SM PDU session modification Command message towards the UE including the QoS rule(s) and QoS Flow level QoS parameters if needed for the QoS Flow(s) associated with the QoS rule(s) and QoS rule operation and the QoS Flow level QoS parameters operation) service operation to the V-SMF.

Based on operator policies and roaming agreements, the V-SMF may decide to fully accept or reject the QoS information provided by the H-SMF. The V-SMF shall also be able to accept a subset of the QoS flows requested to be created or modified within a single H-SMF request i.e. V-SMF can accept some OoS flows and reject other OoS flows in same response to H-SMF.

15. V-SMF responds to the H-SMF with an Nsmf_PDUSession_Update response carrying the information like PCO provided by the UE in the SM PDU session modification Command Ack message from the UE to the V-SMF, Secondary RAT usage data. The H-SMF shall modify the PDU Session context.

If the V-SMF has rejected QFI(s) (step3) or the (R)AN has rejected QFI(s) in step 6 of FIG. 4.3.3.2-1, the H-SMF is responsible of later updating the QoS rules and QoS Flow level QoS parameters if needed for the QoS Flow(s) associated with the QoS rule(s) in the UE.

For other steps of FIG. 1b that have been described in clause 4.3.3.3 of 3GPP TS 23.502 V18.0.0, the description thereof is omitted here for brevity.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

As described in clause 5.2.2.8.3.1 of 3GPP TS 29.502 V18.1.0, the disclosure of which is incorporated by reference herein in its entirety, for network (e.g. H-SMF, SMF) requested PDU session modification, the V-SMF or I-SMF may accept all or only a subset of the QoS flows requested to be created or modified within the request. The list of QoS flows which have been successfully setup or modified, and those which failed to be so, if any, shall be included in the qosFlowsAddModList information element (IE) and/or the qosFlowsFailedtoAddModList IE respectively. H-SMF is responsible for trigger a modification to the UE based on the qosFlowsFailedtoAddModList IE.

Table 1 shows the qosFlowsFailedtoAddModList IE, which is an attribute of VsmfUpdatedData as described in Table 6.1.6.2.16-1 of 3GPP TS 29.502 V18.1.0.

TABLE 1

| Attribute name | Data type | P | Cardinality | Description |
|---|---|---|---|---|
| qosFlowsFailedtoAddModList | array(QosFlowItem) | C | 1 . . . N | This IE shall be present if |
| | | | | QoS flows failed to be |
| | | | | established or modified. |

There may be some problems for the exiting solutions of PDU session establishment and/or modification for home-routed roaming scenarios.

For example, for at least one QoS flow setup/update in PDU session modification and at least one QoS flows setup in PDU session establishment, V-SMF informs H-SMF of the failure or release of QoS flow. If V-SMF rejects a part of the QoS flows (which will not be sent to the UE/RAN (radio access network)), these rejected QoS flows will not be passed to the UE/RAN. The H-SMF will not need to update the UE if the QoS flows was failed to be modified/added due to V-SMF rejection. If the failed QoS flows are due to V-SMF rejection, there is no need for H-SMF to trigger the modification to the UE because the rejected QoS flows are not present in the UE.

However with the exiting solutions, it is not possible to inform H-SMF that NAS (Non-access stratum) update to UE is not needed. It may cause extra NAS update to UE which consumes extra signal which is not needed. In addition it may result in an error report from UE to 5GC (Fifth Generation Core network).

When establishment or modification for certain QoS flows are rejected by V-SMF (e.g., due to VPLMN (Visited Public Land Mobile Network) policy), the H-SMF will perform unnecessary and incorrect N1 update to the UE for the rejected QoS flows which may lead to unexpected result and waste traffic on air interface.

To overcome or mitigate at least one of above mentioned problems or other problems, the embodiments of the present disclosure propose an improved solution for session management.

In a first aspect of the disclosure, there is provided a method performed by a first session management function (SMF). The method comprises sending a first message to a second SMF. The first message comprises a quality of service (QoS) flows setup list comprising one or more QoS flows to establish for a protocol data unit (PDU) session. The method further comprises receiving a second message comprising information of at least one QoS flow failed to be established from the second SMF. The information of at least one QoS flow failed to be established indicates that updating the at least one QoS flow failed to be established to a terminal device is not needed and/or releasing the at least one QoS flow failed to be established to the terminal device is not needed and/or the at least one QoS flow failed to be established is rejected by the second SMF.

In an embodiment, the method further comprises skipping updating the at least one QoS flow failed to be established to the terminal device.

In an embodiment, the method further comprises skipping releasing the at least one QoS flow failed to be established to the terminal device.

In an embodiment, the first message comprises a PDU session create response and the second message comprises a PDU session update request.

In an embodiment, the information of at least one QoS flow failed to be established is comprised in home SMF update data.

In an embodiment, the information of at least one QoS flow failed to be established is comprised in a QoS flows visited SMF rejected list.

In an embodiment, the information of at least one QoS flow failed to be established is comprised in a list of QoS flows not needed for releasing to the terminal device.

In an embodiment, the information of at least one QoS flow failed to be established indicates which QoS flow(s) in a QoS flows release notify list is rejected by the second SMF and/or not needed for releasing to the terminal device.

In an embodiment, the second message further comprises a QoS flows release notify list comprising one or more QoS flows that have been released or rejected.

In an embodiment, the first message is sent and the second message is received during a user equipment (UE) requested PDU session establishment for home-routed roaming scenario.

In an embodiment, the second SMF is a visited SMF and the first SMF is a home SMF.

In a second aspect of the disclosure, there is provided a method performed by a first session management function (SMF). The method comprises sending a first message to a second SMF. The first message comprises a quality of service (QoS) flows addition modification request list comprising one or more QoS flows requested to be established or modified. The method further comprises receiving a second message comprising information of at least one QoS flow failed to be added/modified from the second SMF. The information of at least one QoS flow failed to be added/modified indicates that updating the at least one QoS flow failed to be added/modified to a terminal device is not needed and/or the at least one QoS flow failed to be added/modified is rejected by the second SMF.

In an embodiment, the method further comprises skipping updating the at least one QoS flow failed to be added/modified to the terminal device.

In an embodiment, the first message comprises a protocol data unit (PDU) session update request and the second message comprises a PDU session update response.

In an embodiment, the information of at least one QoS flow failed to be added/modified is comprised in visited SMF updated data.

In an embodiment, the information of at least one QoS flow failed to be added/modified is comprised in a QoS flows visited SMF rejected addition modification list.

In an embodiment, the information of at least one QoS flow failed to be added/modified is comprised in a list of QoS flows which are failed to be added/modified and not need for updating to the terminal device.

In an embodiment, the information of at least one QoS flow failed to be added/modified indicates which QoS flow(s) in a QoS flows failed to addition modification list is rejected by the second SMF and/or not needed for updating to the terminal device.

In an embodiment, the second message further comprises a QoS flows failed to addition modification list comprising one or more QoS flows failed to be established or modified.

In an embodiment, the first message is sent and the second message is received during a UE or network requested PDU session modification for home-routed roaming scenario.

In an embodiment, the second SMF is a visited SMF and the first SMF is a home SMF.

In a third aspect of the disclosure, there is provided a method performed by a second SMF. The method comprises receiving a first message from a first SMF. The first message comprises a quality of service (QoS) flows setup list comprising one or more QoS flows to establish for a protocol data unit (PDU) session. The method further comprises sending a second message comprising information of at least one QoS flow failed to be established to the first SMF.

The information of at least one QoS flow failed to be established indicates that updating the at least one QoS flow failed to be established to a terminal device is not needed and/or releasing the at least one QoS flow failed to be established to the terminal device is not needed and/or the at least one QoS flow failed to be established is rejected by the second SMF.

In an embodiment, the first message comprises a PDU session create response and the second message comprises a PDU session update request.

In an embodiment, the information of at least one QoS flow failed to be established is comprised in home SMF update data.

In an embodiment, the information of at least one QoS flow failed to be established is comprised in a QoS flows visited SMF rejected list.

In an embodiment, the information of at least one QoS flow failed to be established is comprised in a list of QoS flows not needed for releasing to the terminal device.

In an embodiment, the information of at least one QoS flow failed to be established indicates which QoS flow(s) in a QoS flows release notify list is rejected by the second SMF and/or not needed for releasing to the terminal device.

In an embodiment, the second message further comprises a QoS flows release notify list comprising one or more QoS flows that have been released or rejected.

In an embodiment, the first message is received and the second message is sent during a user equipment (UE) requested PDU session establishment for home-routed roaming scenario.

In an embodiment, the second SMF is a visited SMF and the first SMF is a home SMF.

In a fourth aspect of the disclosure, there is provided a method performed by a second SMF. The method comprises receiving a first message from a first SMF. The first message comprises a quality of service (QoS) flows addition modification request list comprising one or more QoS flows requested to be established or modified. The method further comprises sending a second message comprising information of at least one QoS flow failed to be added/modified to the first SMF. The information of at least one QoS flow failed to be added/modified indicates that updating the at least one QoS flow failed to be added/modified to a terminal device is not needed and/or the at least one QoS flow failed to be added/modified is rejected by the second SMF.

In an embodiment, the first message comprises a protocol data unit (PDU) session update request and the second message comprises a PDU session update response.

In an embodiment, the information of at least one QoS flow failed to be added/modified is comprised in visited SMF updated data.

In an embodiment, the information of at least one QoS flow failed to be added/modified is comprised in a QoS flows visited SMF rejected addition modification list.

In an embodiment, the information of at least one QoS flow failed to be added/modified is comprised in a list of QoS flows which are failed to be added/modified and not need for updating to the terminal device.

In an embodiment, the information of at least one QoS flow failed to be added/modified indicates which QoS flow(s) in a QoS flows failed to addition modification list is rejected by the second SMF and/or not needed for updating to the terminal device.

In an embodiment, the second message further comprises a QoS flows failed to addition modification list comprising one or more QoS flows failed to be established or modified.

In an embodiment, the first message is received and the second message is sent during a user equipment (UE) requested PDU session establishment for home-routed roaming scenario.

In an embodiment, the second SMF is a visited SMF and the first SMF is a home SMF.

In a fifth aspect of the disclosure, there is provided a first SMF. The first SMF comprises a processor and a memory coupled to the processor. Said memory contains instructions executable by said processor. Said first SMF is operative to send a first message to a second SMF. The first message comprises a quality of service (QoS) flows setup list comprising one or more QoS flows to establish for a protocol data unit (PDU) session. Said first SMF is further operative to receive a second message comprising information of at least one QoS flow failed to be established from the second SMF. The information of at least one QoS flow failed to be established indicates that updating the at least one QoS flow failed to be established to a terminal device is not needed and/or releasing the at least one QoS flow failed to be established to the terminal device is not needed and/or the at least one QoS flow failed to be established is rejected by the second SMF.

In a sixth aspect of the disclosure, there is provided a first SMF. The first SMF comprises a processor and a memory coupled to the processor. Said memory contains instructions executable by said processor. Said first SMF is operative to send a first message to a second SMF. The first message comprises a quality of service (QoS) flows addition modification request list comprising one or more QoS flows requested to be established or modified. Said first SMF is further operative to receive a second message comprising information of at least one QoS flow failed to be added/modified from the second SMF. The information of at least one QoS flow failed to be added/modified indicates that updating the at least one QoS flow failed to be added/modified to a terminal device is not needed and/or the at least one QoS flow failed to be added/modified is rejected by the second SMF.

In a seventh aspect of the disclosure, there is provided a second SMF. The second SMF comprises a processor and a memory coupled to the processor. Said memory contains instructions executable by said processor. Said second SMF is operative to receive a first message from a first SMF. The first message comprises a quality of service (QoS) flows setup list comprising one or more QoS flows to establish for a protocol data unit (PDU) session. Said second SMF is further operative to send a second message comprising information of at least one QoS flow failed to be established to the first SMF. The information of at least one QoS flow failed to be established indicates that updating the at least one QoS flow failed to be established to a terminal device is not needed and/or releasing the at least one QoS flow failed to be established to the terminal device is not needed and/or the at least one QoS flow failed to be established is rejected by the second SMF.

In an eighth aspect of the disclosure, there is provided a second SMF. The second SMF comprises a processor and a memory coupled to the processor. Said memory contains instructions executable by said processor. Said second SMF is operative to receive a first message from a first SMF. The first message comprises a quality of service (QoS) flows addition modification request list comprising one or more QoS flows requested to be established or modified. Said second SMF is further operative to send a second message comprising information of at least one QoS flow failed to be added/modified to the first SMF. The information of at least one QoS flow failed to be added/modified indicates that updating the at least one QoS flow failed to be added/modified to a terminal device is not needed and/or the at least one QoS flow failed to be added/modified is rejected by the second SMF.

In another aspect of the disclosure, there is provided a first SMF. The first SMF comprises a sending module configured to send a first message to a second SMF. The first message may comprise a QoS flows setup list comprising one or more QoS flows to establish for a protocol data unit (PDU) session. The first SMF further comprises a receiving module configured to receive a second message comprising information of at least one QoS flow failed to be established from the second SMF. The information of at least one QoS flow failed to be established indicates that updating the at least one QoS flow failed to be established to a terminal device is not needed and/or releasing the at least one QoS flow failed to be established to the terminal device is not needed and/or the at least one QoS flow failed to be established is rejected by the second SMF.

In an embodiment, the first SMF further comprises a first skipping module configured to skip updating the at least one QoS flow failed to be established to the terminal device.

In an embodiment, the first SMF further comprises a second skipping module configured to skip releasing the at least one QoS flow failed to be established to the terminal device.

In another aspect of the disclosure, there is provided a first SMF. The first SMF comprises a sending module configured to send a first message to a second SMF. The first message may comprise a quality of service (QoS) flows addition modification request list comprising one or more QoS flows requested to be established or modified. The first SMF further comprises a receiving module configured to receive a second message comprising information of at least one QoS flow failed to be added/modified from the second SMF. The information of at least one QoS flow failed to be added/modified indicates that updating the at least one QoS flow failed to be added/modified to a terminal device is not needed and/or the at least one QoS flow failed to be added/modified is rejected by the second SMF.

In an embodiment, the first SMF further comprises a skipping module configured to skip updating the at least one QoS flow failed to be added/modified to the terminal device.

In another aspect of the disclosure, there is provided a second SMF. The second SMF comprises a receiving module configured to receive a first message from a first SMF. The first message may comprise a QoS flows setup list comprising one or more QoS flows to establish for a PDU session. The second SMF further comprises a sending module configured to send a second message comprising information of at least one QoS flow failed to be established to the first SMF. The information of at least one QoS flow failed to be established indicates that updating the at least one QoS flow failed to be established to a terminal device is not needed and/or releasing the at least one QoS flow failed to be established to the terminal device is not needed and/or the at least one QoS flow failed to be established is rejected by the second SMF.

In another aspect of the disclosure, there is provided a second SMF. The second SMF comprises a receiving module configured to receive a first message from a first SMF. The first message may comprise a quality of service (QoS) flows addition modification request list comprising one or more QoS flows requested to be established or modified. The second SMF further comprises a sending module configured to send a second message comprising information of at least one QoS flow failed to be added/modified to the first SMF. The information of at least one QoS flow failed to be added/modified indicates that updating the at least one QoS flow failed to be added/modified to a terminal device is not needed and/or the at least one QoS flow failed to be added/modified is rejected by the second SMF.

In another aspect of the disclosure, there is provided a computer program product comprising instructions which when executed by at least one processor, cause the at least one processor to perform the method according to any one of the first or second or third or fourth aspects.

In another aspect of the disclosure, there is provided a computer-readable storage medium storing instructions which when executed by at least one processor, cause the at least one processor to perform the method according to any one of the first or second or third or fourth aspects.

Embodiments herein may provide many advantages, of which a non-exhaustive list of examples follows. In some embodiments herein, it can avoid extra procedure which may cause an error report from UE. In some embodiments herein, it can reduce signaling usage between the first network such as HPLMN (Home Public Land Mobile Network) and the second network such as VPLMN. In some embodiments, the solution can be extended to simplify the handling of other scenarios when V-SMF determines that updating QoS rule/QoS flow description to UE is not needed. In some embodiments herein, it can avoid the first SMF such as H-SMF to perform unnecessary and incorrect N1 update to the UE for the QoS flows rejected by the second SMF such as V-SMF, which can avoid unexpected result and save traffic on air interface. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a shows a flowchart of UE-requested PDU session establishment for home-routed roaming scenarios;

FIG. 1b shows a flowchart of UE or network requested PDU session modification for home-routed roaming scenario;

FIG. 2 schematically shows 5G system roaming architecture in the case of home routed scenario using the reference point representation according to an embodiment of the present disclosure;

FIG. 3 shows a flowchart of at least one QoS flow addition/modification in PDU session modification according to an embodiment of the present disclosure;

FIG. 4 shows a flowchart of QoS flows setup in PDU session setup procedure according to an embodiment of the present disclosure;

FIG. 5a shows a flowchart of a method according to an embodiment of the present disclosure;

FIG. 5b shows a flowchart of a method according to another embodiment of the present disclosure;

FIG. 5c shows a flowchart of a method according to another embodiment of the present disclosure;

FIG. 5d shows a flowchart of a method according to another embodiment of the present disclosure;

FIG. 6a shows a flowchart of a method according to another embodiment of the present disclosure;

FIG. 6b shows a flowchart of a method according to another embodiment of the present disclosure;

FIG. 7a shows a flowchart of at least one QoS flow addition/modification in PDU session modification according to another embodiment of the present disclosure;

FIG. 7b shows a flowchart of at least one QoS flows setup in PDU session setup procedure according to another embodiment of the present disclosure;

FIG. 8a is a block diagram showing an apparatus suitable for practicing some embodiments of the disclosure;

FIG. 8b is a block diagram showing a first SMF according to an embodiment of the disclosure;

FIG. 8c is a block diagram showing a first SMF according to another embodiment of the disclosure;

FIG. 8d is a block diagram showing a second SMF according to an embodiment of the disclosure;

FIG. 8e is a block diagram showing a second SMF according to another embodiment of the disclosure;

FIG. 9 shows an example of a communication system according to an embodiment of the disclosure;

FIG. 10 is a block diagram of a host according to an embodiment of the disclosure; and

FIG. 11 shows a communication diagram of a host communicating via a network node with a UE over a partially wireless connection according to an embodiment of the disclosure.

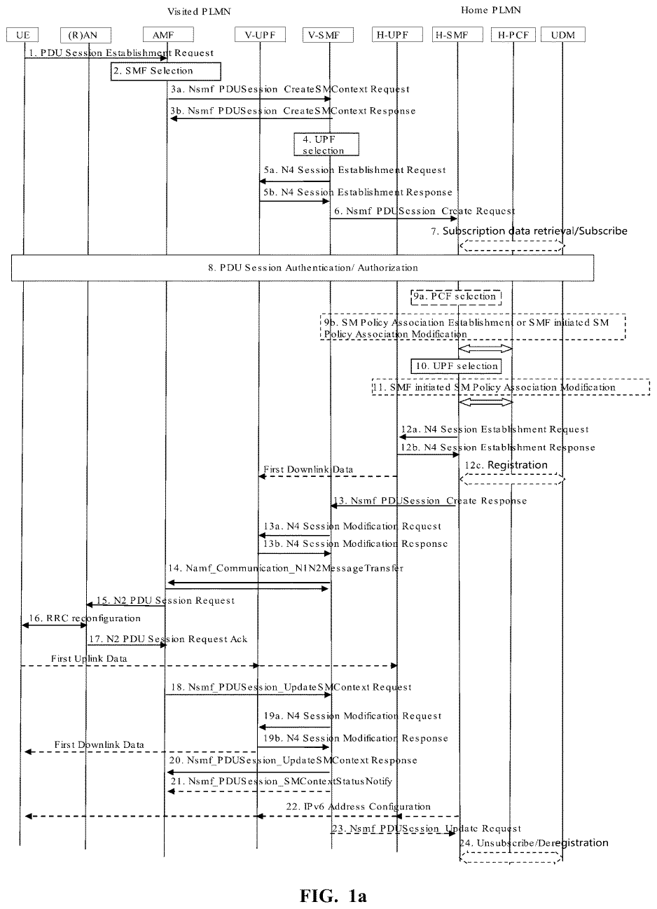

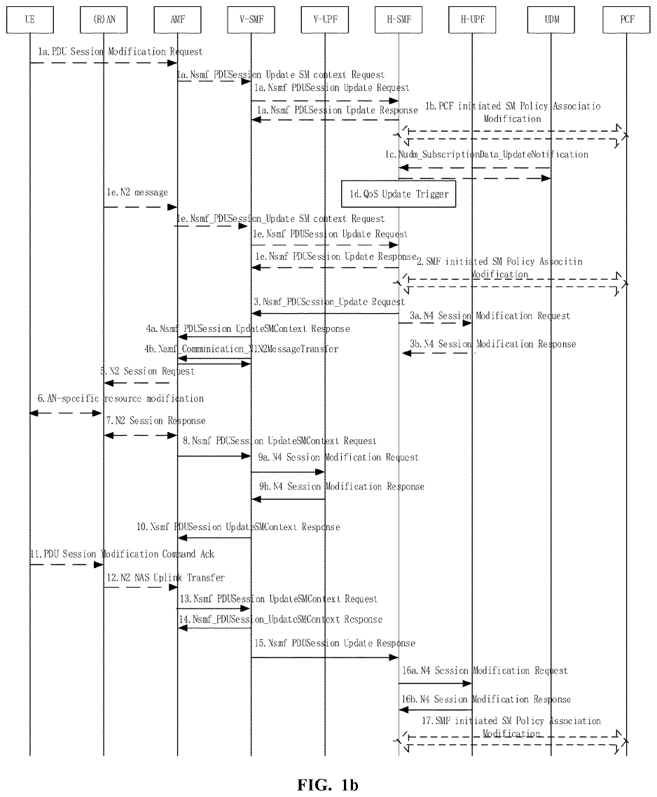

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G, 6G communication protocols, and/or any other protocols either currently known or to be developed in the future.

The term “network device” or “network node” refers to any suitable network function (NF) which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE (Long Term Evolution)) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

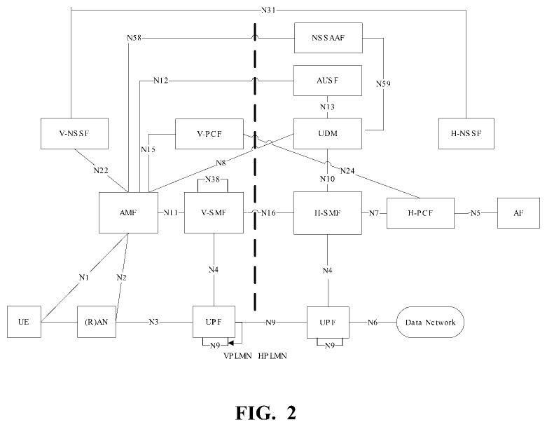

Although the subject matter described herein may be implemented in any appropriate type of system using any suitable components, the embodiments disclosed herein are described in relation to a communication system complied with the exemplary system architecture illustrated in FIG. 2. For simplicity, the system architecture of FIG. 2 only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

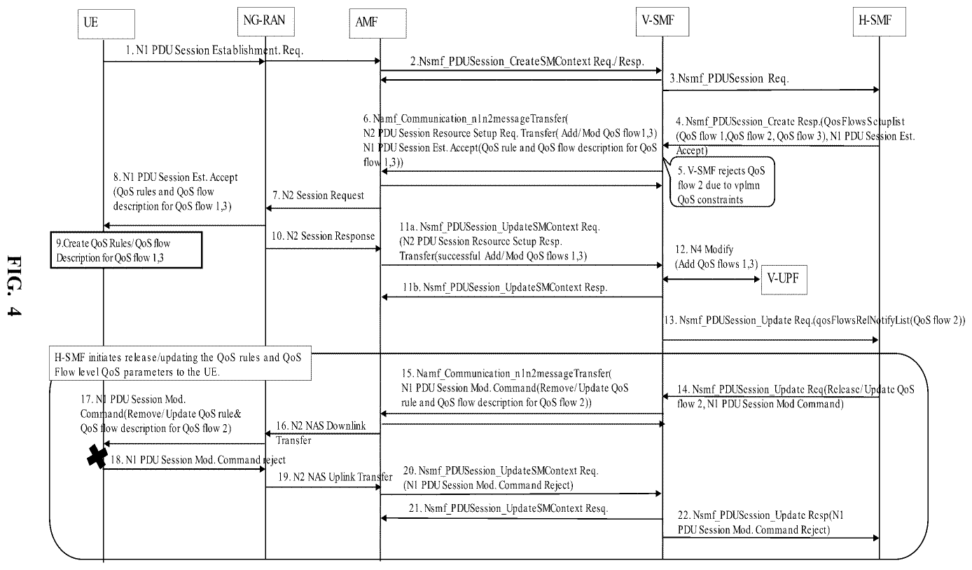

FIG. 2 schematically shows 5G system roaming architecture in the case of home routed scenario using the reference point representation according to an embodiment of the present disclosure. The architecture of FIG. 2 is same as FIG. 4.2.4-6 as described in 3GPP TS 23.501 V18.0.0, the disclosure of which is incorporated by reference herein in its entirety. The system architecture of FIG. 2 may comprise some exemplary elements such as AUSF, AMF, data network, visited NSSF (V-NSSF), home NSSF (H-NSSF), visited PCF (V-PCF), visited SMF

(V-SMF), home SMF (H-SMF), UDM, UPF, AF, UE, (R)AN, NSSAAF (Network Slice-Specific Authentication and Authorization Function), etc.

In accordance with an exemplary embodiment, the UE can establish a signaling connection with the AMF over the reference point N1, as illustrated in FIG. 2. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the data network (e.g. an operator network or Internet) through the UPF over the reference point N6.

The N38 references point can be between V-SMFs in the same VPLMN, or between V-SMFs in different VPLMNs (to enable inter-PLMN mobility).

For the roaming scenarios described above each PLMN implements proxy functionality to secure interconnection and hide topology on the inter-PLMN interfaces.

As further illustrated in FIG. 2, it also shows some reference points such as N1, N2, N3, N4, N6, N9, N11, N38, N16, N7, N5, N22, N15, N8, N24, N10, N58, N12, N31, N59, N13 etc., which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 2 may be responsible for functions such as session management, mobility management, authentication, security, etc. Various NFs shown in FIG. 2 may include the functionality for example as defined in clause 6.2 of 3GPP TS 23.501 V18.0.0.

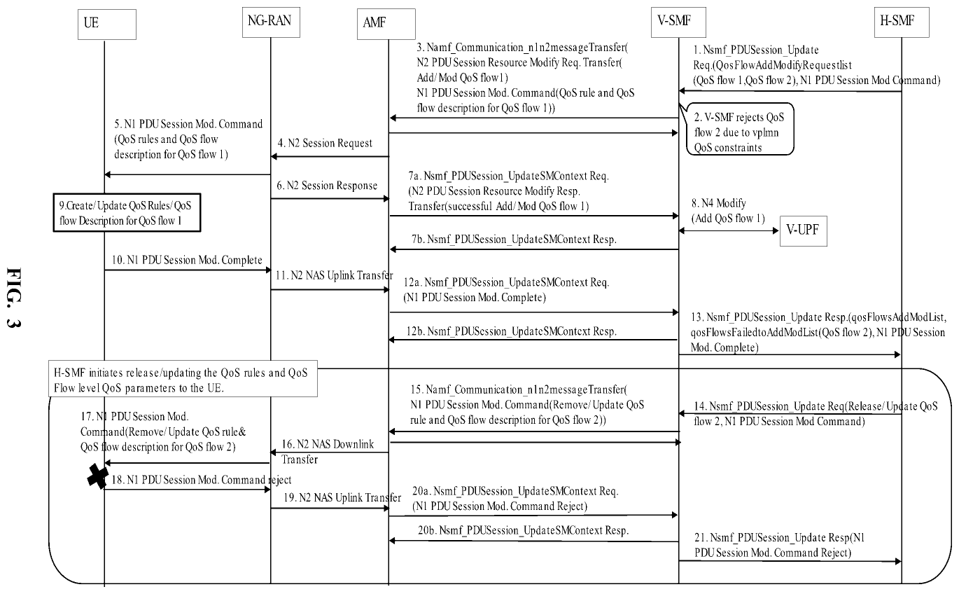

FIGS. 3 and 4 shows some problems for the exiting solutions of PDU session establishment and/or modification for home-routed roaming scenarios.

FIG. 3 shows a flowchart of at least one QoS flow addition/modification in PDU session modification according to an embodiment of the present disclosure.

Step 1. H-SMF sends an Nsmf_PDUSession_Update Request (QosFlowAddModifyRequestlist (QoS flow 1, QoS flow 2), N1 PDU session modification Command) to V-SMF.

Step 2. V-SMF rejects a QoS flow 2 e.g. due to VPLMN QoS constraints.

Step 3. V-SMF sends an Namf_Communication_nln2messageTransfer (N2 PDU Session Resource Modify Request Transfer (Add/Modify QoS flow1), N1 PDU session modification Command (QoS rule and QoS flow description for QoS flow 1)) to AMF and receives a response from AMF.

Step 4. AMF sends an N2 Session Request to NG-RAN (next generation RAN).

Step 5. NG-RAN sends an N1 PDU session modification Command (QoS rules and QoS flow description for QoS flow 1) to UE.

Step 6. NG-RAN sends an N2 Session Response to AMF.

Step 7a. AMF sends an Nsmf_PDUSession_UpdateSMContext Request (N2 PDU Session Resource Modify Response Transfer (successful addition/modification QoS flow 1) to V-SMF.

Step 7b. V-SMF sends an Nsmf_PDUSession_UpdateSMContext Response to AMF.

Step 8. V-SMF sends an N4 Modify (Add QoS flow 1) to V-UPF.

Step 9. UE creates/updates QoS Rules/QoS flow Description for QoS flow 1.

Step 10. UE sends an N1 PDU session modification Complete to NG-RAN.

Step 11. NG-RAN sends a N2 NAS UPlink Transfer to AMF.

Step 12a. AMF sends an Nsmf_PDUSession_UpdateSMContext Request (N1 PDU session modification Complete) to V-SMF.

Step 12b. V-SMF sends an Nsmf_PDUSession_UpdateSMContext Response to AMF.

Step 13. V-SMF sends an Nsmf_PDUSession_Update Response. (qosFlowsAddModList, qosFlowsFailedtoAddModList (QoS flow 2), N1 PDU session modification Complete) to H-SMF.

H-SMF initiates release/updating the QoS rules and QoS Flow level QoS parameters to the UE as following.

Step 14. H-SMF sends an Nsmf_PDUSession_Update Request (Release/Update QoS flow 2, N1 PDU Session Mod Command) to V-SMF.

Step 15. V-SMF sends an Namf_Communication_nln2messageTransfer (N1 PDU session modification Command (Remove/Update QoS rule and QoS flow description for QoS flow 2)) to AMF and receives a response from AMF.

Step 16. AMF sends an N2 NAS Downlink Transfer to NG-RAN.

Step 17. NG-RAN sends an N1 PDU session modification Command (Remove/Update QoS rule& QoS flow description for QoS flow 2) to UE.

Step 18. UE sends an N1 PDU session modification Command reject to NG-RAN.

Step 19. NG-RAN sends an N2 NAS Uplink Transfer to AMF.

Step 20a. AMF sends an Nsmf_PDUSession_UpdateSMContext Request (N1 PDU session modification Command Reject) to V-SMF.

Step 20b. V-SMF sends an Nsmf_PDUSession_UpdateSMContext Response to AMF.

Step 21. V-SMF sends an Nsmf_PDUSession_Update Response (N1 PDU session modification Command Reject) to H-SMF.

The messages of FIG. 3 may be same as the corresponding messages as described in various 3GPP specifications such as 3GPP TS 29.502 V18.1.0, 3GPP TS 23.502 V18.0.0, etc.

When V-SMF rejects a subset of QoS flow addition/modification, V-SMF doesn't issue a request to RAN and UE for the rejected QoS flow. After receiving a response from RAN/UE, V-SMF includes the rejected QoS flow in qosFlowsFailedtoAddModList IE to H-SMF. The H-SMF initiates updating the QoS rules and QoS Flow level QoS parameters to the UE, which may cause an error report from UE, as V-SMF doesn't issue a request to UE for the rejected QoS flow(s).

For QoS flow Addition/modification initiated by H-SMF (Step 1), a sub-set of QoS flow is rejected by V-SMF (Step 2). V-SMF may continue to send a request to RAN/UE to Add/Modify other QoS flows (Steps 3-12).

V-SMF may report QoS flow failure to H-SMF (Step 13) and then H-SMF initiates updating of the QoS rules and QoS Flow level QoS parameters to the UE for the failed QoS flow (Step 14-21), which is not needed as the QoS rule/QoS flow description for the failed QoS flow are not sent to UE.

UE may reject the updating in Step 18 and RAN/AMF forwards it to V-SMF/H-SMF, if it is to release non-existing QoS flow.

H-SMF initiates updating of the QoS rules and QoS Flow level QoS parameters to the UE for the failed QoS flows (Steps 14-21), which is not needed.

FIG. 4 shows a flowchart of QoS flows setup in PDU session setup procedure according to an embodiment of the present disclosure.

Step 1. UE sends an N1 PDU session establishment Request to AMF via NG-RAN.

Step 2. AMF sends an Nsmf_PDUSession_CreateSMContext Request to V-SMF and receives a response from V-SMF.

Step 3. V-SMF sends an Nsmf_PDUSession Request to H-SMF.

Step 4. H-SMF sends an Nsmf_PDUSession_Create Response (QosFlowsSetuplist (QoS flow 1, QoS flow 2, QoS flow 3), N1 PDU session establishment Accept) to V-SMF.

Step 5. V-SMF rejects a QoS flow 2 e.g. due to VPLMN QoS constraints

Step 6. V-SMF sends an Namf_Communication_nln2messageTransfer (N2 PDU Session Resource Setup Request Transfer (Add/Modify QoS flow1, 3), N1 PDU session establishment Accept (QoS rule and QoS flow description for QoS flows 1,3)) to AMF and receive a response from AMF.

Step 7. AMF sends an N2 Session Request to NG-RAN.

Step 8. NG-RAN sends an N1 PDU session establishment Accept (QoS rules and QoS flow description for QoS flows 1, 3) to UE.

Step 9. UE creates QoS Rules/QoS flow description for QoS flows 1, 3.

Step 10. NG-RAN sends an N2 Session Response to AMF.

Step 11a. AMF sends an Nsmf_PDUSession_UpdateSMContext Request (N2 PDU Session Resource Setup Response Transfer (successful addition/modification QoS flows 1, 3) to V-SMF.

Step 11b. V-SMF sends an Nsmf_PDUSession_UpdateSMContext Response to AMF.

Step 12. V-SMF sends an N4 Modify (Add QoS flows 1, 3) to V-UPF.

Step 13. V-SMF sends Nsmf_PDUSession_Update Request (qosFlowsRelNotifyList (QoS flow 2)) to H-SMF.

H-SMF initiates release/updating the QoS rules and QoS flow level QoS parameters to the UE as following.

Step 14. H-SMF sends an Nsmf_PDUSession_Update Request (Release/Update QoS flow 2, N1 PDU Session Mod Command) to V-SMF.

Step 15. V-SMF sends an Namf_Communication_nln2messageTransfer (N1 PDU session modification Command (Remove/Update QoS rule and QoS flow description for QoS flow 2)) to AMF. AMF sends a response to V-SMF.

Step 16. AMF sends an N2 NAS Downlink Transfer to NG-RAN.

Step 17. NG-RAN sends an N1 PDU session modification Command (Remove/Update QoS rule& QoS flow description for QoS flow 2) to UE.

Step 18. UE sends an N1 PDU session modification Command reject to NG-RAN.

Step 19. NG-RAN sends an N2 NAS Uplink Transfer to AMF.

Step 20. AMF sends an Nsmf_PDUSession_UpdateSMContext Request (N1 PDU session modification Command Reject) to V-SMF.

Step 21. V-SMF sends an Nsmf_PDUSession_UpdateSMContext Response to AMF.

Step 22. V-SMF sends an Nsmf_PDUSession_Update Resp (N1 PDU session modification Command Reject) to H-SMF.

The messages of FIG. 4 may be same as the corresponding messages as described in various 3GPP specifications such as 3GPP TS 29.502 V18.1.0, 3GPP TS 23.502 V18.0.0, etc.

When V-SMF rejects a subset of QoS flow Setup, V-SMF doesn't issue a request to RAN and UE for the rejected QoS flow.

For the rejected QoS flow, V-SMF initiates QoS flow release to H-SMF and then H-SMF initiates QoS flow release to UE.

For at least one QoS flow setup initiated by H-SMF (Step 4), a sub-set of QoS flow is rejected by V-SMF (Step 5) and default QoS is accepted. V-SMF continues to send a request to RAN/UE to setup other QoS flows (Steps 3-12).

For the rejected QoS flow(s), V-SMF initiated QoS flow release to H-SMF (Step 13) and then H-SMF initiates release of the QoS rules and QoS Flow level QoS parameters to the UE (Steps 14-17).

UE may reject the updating in Step 18 and RAN/AMF forward the PDU session modification Command Reject (Step 19-22) to V-SMF/H-SMF, if it is to release non-existing QoS flow.

Therefore for the QoS flow(s) rejected by V-SMF, steps 14-17 are not needed.

From FIGS. 3 and 4, it is not possible to inform H-SMF that NAS update to UE is not needed. It may cause extra NAS update to UE which consumes extra signal which is not needed. In addition it may result in an error report from UE to 5GC.

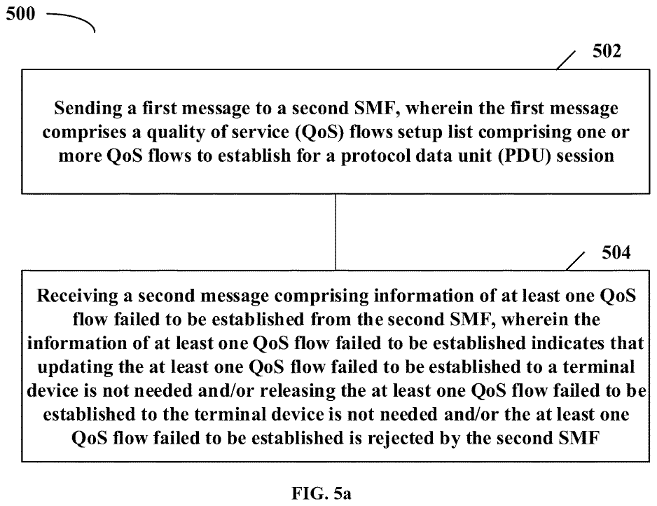

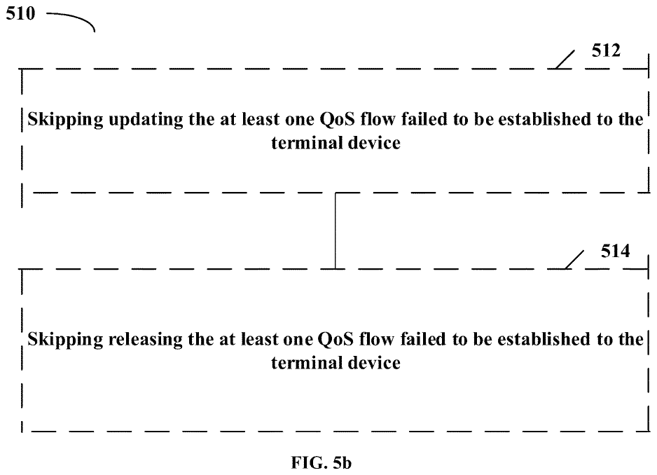

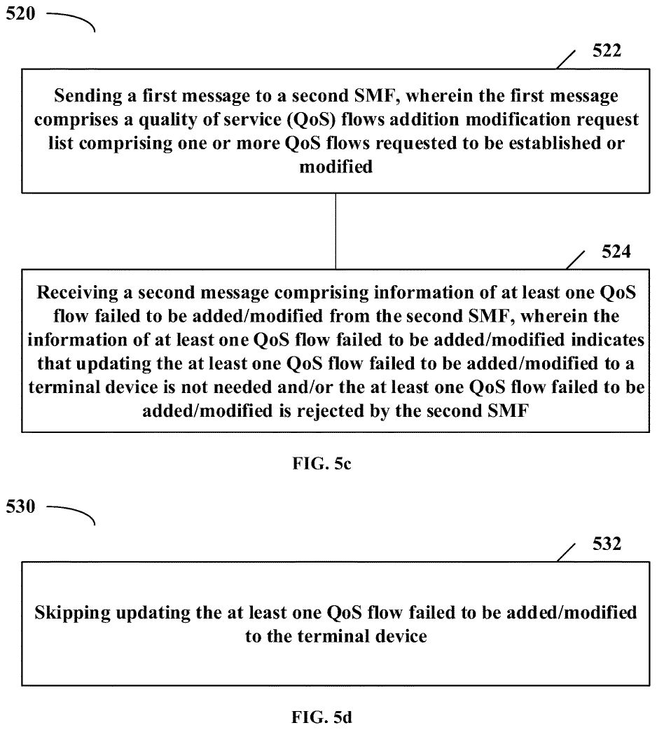

FIG. 5a shows a flowchart of a method according to an embodiment of the present disclosure, which may be performed by an apparatus implemented in or at or as a first session management function (SMF) or communicatively coupled to the first SMF. As such, the apparatus may provide means or modules for accomplishing various parts of the method 500 as well as means or modules for accomplishing other processes in conjunction with other components.

At block 502, the first SMF may send a first message to a second SMF. The first message may comprise a quality of service (QoS) flows setup list comprising one or more QoS flows to establish for a protocol data unit (PDU) session.

The first SMF may be any suitable network device or node or entity or function which can provide session management function. In an embodiment, the first SMF may be an SMF or a Packet Data Network Gateway control plane (PGW-C) combined with SMF (PGW-C+SMF) or a home SMF or anchor SMF (A-SMF) as described in 3GPP TS 23.501 V18.0.0. For example, the H-SMF may be an SMF that is located in a home network.

The second SMF may be any suitable network device or node or entity or function which can provide session management function. In an embodiment, the second SMF may be an intermediate SMF (I-SMF) or a visited SMF (V-SMF) as described in 3GPP TS 23.501 V18.0.0.

For example, the I-SMF may be an SMF that is inserted to support a PDU session as the UE is located in an area which cannot be controlled by the original SMF because the UPF(s) belong to a different SMF service area. For example, the V-SMF may be an SMF that is inserted to support a PDU session as the UE is located in a visited network which cannot be controlled by the home SMF because the UPF(s) belong to the visited network.

In an embodiment, the second SMF may be a visited SMF and the first SMF may be a home SMF.

In an embodiment, the second SMF may be a SMF in a second network and the first SMF may be a SMF in a first network.

In an embodiment, the second SMF may be a SMF in a second service area and the first SMF may be a SMF in a first service area.

The first message may be any suitable message which can be sent from the first SMF to the second SMF.

In an embodiment, the first message may comprise a PDU session create response such as Nsmf_PDUSession_Create Response as described in 3GPP TS 23.502 V18.0.0.

In an embodiment, the first message may be the Nsmf_PDUSession_Create Response of step 13 of FIG. 4.3.2.2.2-1 as described in 3GPP TS 23.502 V18.0.0.

In an embodiment, the QoS flows setup list may be same as the qosFlowsSetupList as described in 3GPP TS 29.502 V18.1.0. For example, the Nsmf_PDUSession_Create Response may comprise the qosFlowsSetupList.

At block 504, the first SMF may receive a second message comprising information of at least one QoS flow failed to be established from the second SMF. The information of at least one QoS flow failed to be established may indicate that updating the at least one QoS flow failed to be established to a terminal device is not needed and/or releasing the at least one QoS flow failed to be established to the terminal device is not needed and/or the at least one QoS flow failed to be established is rejected by the second SMF.

The at least one QoS flow failed to be established may be rejected by the second SMF due to various reasons and the present disclosure has no limit on it. For example, the second SMF (such as V-SMF) in the second network may apply second network policies (such as VPLMN policies) related with the SLA (Service Level Agreement) negotiated with the first network such as HPLMN or with QoS values supported by the second network (such as VPLMN) to evaluate the QoS parameters received from the first SMF (such as H-SMF) in the first network. Such policies may result in that the second SMF (such as V-SMF) does not accept the PDU session or does not accept at least one of the QoS flows requested by the first SMF (such as H-SMF). If the second SMF (such as V-SMF) does not accept the PDU session, the second SMF (such as V-SMF) triggers the second SMF initiated PDU session release procedure. When the second SMF (such as V-SMF) accepts at least one QoS flow, it transfers (e.g., via the AMF) the corresponding N2 (and NAS) request towards the 5G AN (access network) (and the UE) but does not issue requests for the QoS Flow(s) it has rejected due to various reasons. The second SMF (such as V-SMF) notifies the first SMF (such as H-SMF) about the QoS flows rejected by the second SMF (such as V-SMF).

For example, based on operator policies and roaming agreements, the second SMF (such as V-SMF) may decide to fully accept or reject the QoS information provided by the first SMF (such as H-SMF). The second SMF (such as V-SMF) may also be able to accept a subset of the QoS flows requested to be created or established within the first message, i.e. the second SMF (such as V-SMF) can accept some QoS flows and reject the other QoS flows in a same message to the first SMF (such as H-SMF).

The second SMF (such as V-SMF) may determine updating the at least one QoS flow failed to be established to a terminal device is not needed in various ways and the present disclosure has no limit on it. For example, when the at least one QoS flow failed to be established is rejected by the second SMF (such as V-SMF) or visited UPF or not present in the terminal device, the second SMF (such as V-SMF) may determine updating the at least one QoS flow failed to be established to a terminal device is not needed.

The second SMF (such as V-SMF) may determine releasing the at least one QoS flow failed to be established to the terminal device is not needed in various ways and the present disclosure has no limit on it. For example, when the at least one QoS flow failed to be established is rejected by the second SMF (such as V-SMF) or visited UPF or not present in the terminal device, the second SMF (such as V-SMF) may determine releasing the at least one QoS flow failed to be established to a terminal device is not needed.

The second message may be any suitable message which can be sent from the second SMF to the first SMF.

In an embodiment, the second message may comprise a PDU session update request such as Nsmf_PDUSession_Update request as described in 3GPP TS 23.502 V18.0.0.

In an embodiment, the second message may be the Nsmf_PDUSession_Update request of step 23 of FIG. 4.3.2.2.2-1 as described in 3GPP TS 23.502 V18.0.0.

In an embodiment, the first message comprises a PDU session create response and the second message comprises a PDU session update request.

The information of at least one QoS flow failed to be established may be any suitable information which can indicate that updating the at least one QoS flow failed to be established to a terminal device is not needed and/or releasing the at least one QoS flow failed to be established to the terminal device is not needed and/or the at least one QoS flow failed to be established is rejected by the second SMF.

In an embodiment, the information of at least one QoS flow failed to be established may be comprised in a QoS flows visited SMF rejected list.

In an embodiment, the information of at least one QoS flow failed to be established may be comprised in a list of QoS flows not needed for releasing to the terminal device.

In an embodiment, the information of at least one QoS flow failed to be established may indicate which QoS flow(s) in a QoS flows release notify list is rejected by the second SMF and/or not needed for releasing to the terminal device.

For example, it may introduce a new qosFlowsVsmfRejectedList to include the QoS flow(s) rejected by the second SMF such as V-SMF. The first SMF such as H-SMF will not trigger NAS update to the terminal device for the QoS flow(s) rejected by the second SMF if the qosFlowsVsmfRejectedList is received.

For example, it may introduce a new list of QoS flow(s) not needed for releasing to the terminal device to include the QoS flow(s) not needed for releasing to the terminal device. The first SMF such as H-SMF will not trigger releasing the QoS flow(s) in the new list to the terminal device if the new list is received.

For example, it may introduce a new indication to indicate which QoS flow(s) in the qosFlowsRelNotifyList is rejected by the second SMF or not needed for releasing to the terminal device.

In an embodiment, the information of at least one QoS flow failed to be established may be comprised in home SMF update data. For example, the home SMF update data may be same as the HsmfUpdateData as described in 3GPP TS 29.502 V18.1.0.

In an embodiment, the second message further comprises a QoS flows release notify list comprising one or more QoS flows that have been released or rejected. For example, the one or more QoS flows may be released by a radio access network or rejected by the second SMF. For example, the QoS flows release notify list may be same as qosFlowsRelNotifyList as described in 3GPP TS 29.502 V18.1.0.

In an embodiment, the first message may be sent and the second message may be received during at least one of a user equipment (UE) requested PDU session establishment for home-routed roaming scenario e.g. as described in clause 4.3.2.2.2 of 3GPP TS 23.502 V18.0.0.

FIG. 5b shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 510 as well as means or modules for accomplishing other processes in conjunction with other components. For some parts which have been described in the above embodiments, the description thereof is omitted here for brevity.

At block 512, optionally, the first SMF may skipping updating the at least one QoS flow failed to be established to the terminal device.

At block 514, optionally, the first SMF may skipping releasing the at least one QoS flow failed to be established to the terminal device.

For example, when the first SMF receives the second message comprising information of at least one QoS flow failed to be established indicating that updating the at least one QoS flow failed to be established to a terminal device is not needed and/or releasing the at least one QoS flow failed to be established to the terminal device is not needed and/or the at least one QoS flow failed to be established is rejected by the second SMF, the first SMF may skipping updating or releasing the at least one QoS flow failed to be established to the terminal device.

For example, for the at least one QoS flow failed to be established, the first SMF such as H-SMF shall not initiate updating/release QoS rule/QoS flow description to the terminal device. If V-SMF rejects a part of the QoS flows (which will not be sent to the UE/RAN), these rejected QoS flows will not be passed to the UE/RAN. The H-SMF will not need to update the terminal device if the QoS flows was failed to be added due to V-SMF rejection. If all the failed QoS flows are due to V-SMF rejection, there is no need for H-SMF to trigger updating/release QoS rule/QoS flow description to the terminal device because the rejected QoS flows are not present in the UE.

FIG. 5c shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 520 as well as means or modules for accomplishing other processes in conjunction with other components. For some parts which have been described in the above embodiments, the description thereof is omitted here for brevity.

At block 522, the first SMF may send a first message to a second SMF. The first message may comprise a QoS flows addition modification request list comprising one or more QoS flows requested to be established or modified.

The first SMF may be any suitable network device or node or entity or function which can provide session management function. In an embodiment, the first SMF may be an SMF or a PGW-C+SMF or a home SMF or A-SMF as described in 3GPP TS 23.501 V18.0.0.

The second SMF may be any suitable network device or node or entity or function which can provide session management function. In an embodiment, the second SMF may be an I-SMF or a V-SMF as described in 3GPP TS 23.501 V18.0.0.

In an embodiment, the second SMF may be a visited SMF and the first SMF may be a home SMF.

In an embodiment, the second SMF may be a SMF in a second network and the first SMF may be a SMF in a first network.

In an embodiment, the second SMF may be a SMF in a second service area and the first SMF may be a SMF in a first service area.

The first message may be any suitable message which can be sent from the first SMF to the second SMF.

In an embodiment, the first message may comprise a PDU session update request such as Nsmf_PDUSession_Update Request as described in 3GPP TS 23.502 V18.0.0 or a POST request as described in clause 5.2.2.8.2.2 of 3GPP TS 29.502 V18.1.0 or a POST request as described in clause 5.2.2.8.3.2 of 3GPP TS 29.502 V18.1.0.

In an embodiment, the first message may be the Nsmf_PDUSession_Update Request of step 3 of FIG. 4.3.3.3-1 as described in 3GPP TS 23.502 V18.0.0.

In an embodiment, the QoS flows addition modification request list may be same as the qosFlowsAddModRequestList as described in 3GPP TS 29.502 V18.1.0. For example, the Nsmf_PDUSession_Update Request may comprise the qosFlowsAddModRequestList.

At block 524, the first SMF may receive a second message comprising information of at least one QoS flow failed to be added/modified from the second SMF. The information of at least one QoS flow failed to be added/modified may indicate that updating the at least one QoS flow failed to be added/modified to a terminal device is not needed and/or the at least one QoS flow failed to be added/modified is rejected by the second SMF.

The at least one QoS flow failed to be added/modified may be rejected by the second SMF due to various reasons and the present disclosure has no limit on it.

The second SMF (such as V-SMF) may determine updating the at least one QoS flow failed to be added/modified to the terminal device is not needed in various ways and the present disclosure has no limit on it. For example, when the at least one QoS flow failed to be added/modified is rejected by the second SMF (such as V-SMF) or visited UPF or not present in the terminal device, the second SMF (such as V-SMF) may determine updating the at least one QoS flow failed to be added/modified to a terminal device is not needed.

The second message may be any suitable message which can be sent from the second SMF to the first SMF.

In an embodiment, the second message may comprise a PDU session update response such as Nsmf_PDUSession_Update response as described in 3GPP TS 23.502 V18.0.0 or a POST response as described in clause 5.2.2.8.2.2 of 3GPP TS 29.502 V18.1.0 or a POST response as described in clause 5.2.2.8.3.2 of 3GPP TS 29.502 V18.1.0.

In an embodiment, the second message may be the Nsmf_PDUSession_Update response of step 15 of FIG. 4.3.3.3-1 as described in 3GPP TS 23.502 V18.0.0.

In an embodiment, the first message comprises a PDU session update request and the second message comprises a PDU session update response.

The information of at least one QoS flow failed to be added/modified may be any suitable information which can indicate that that updating the at least one QoS flow failed to be added/modified to a terminal device is not needed and/or the at least one QoS flow failed to be added/modified is rejected by the second SMF.

In an embodiment, the information of at least one QoS flow failed to be added/modified may be comprised in a QoS flows visited SMF rejected addition modification list.

In an embodiment, the information of at least one QoS flow failed to be added/modified may be comprised in a list of QoS flows which are failed to be added/modified and not need for updating to the terminal device.

In an embodiment, the information of at least one QoS flow failed to be added/modified may indicate which QoS flow(s) in a QoS flows failed to addition modification list is rejected by the second SMF and/or not needed for updating to the terminal device.

For example, it may introduce a new qosFlowRejectedAddModList or qosFlowsVsmfRejectedAddModList to distinguish the rejected QoS flow(s) and the failed QoS flow(s). The first SMF such as H-SMF will not trigger NAS update to the terminal device if the qosFlowRejectedAddModList or qosFlowsVsmfRejectedAddModList is received. For example, the rejected QoS flow(s) may be the QoS flow(s) rejected by the second SMF (such as V-SMF) or V-UPF and may be included in the qosFlowRejectedAddModList or qosFlowsVsmfRejectedAddModList. The failed QoS flow(s) may be the QoS flow(s) rejected by the second SMF (such as V-SMF) and/or RAN and may be included in the qosFlowFailedtoAddModList.

For example, it may introduce a new indication to indicate which QoS flow(s) in a QoS flows failed to addition modification list (e.g., qosFlowFailedtoAddModList) is rejected by the second SMF or not needed for updating to the terminal device.

In an embodiment, the information of at least one QoS flow failed to be added/modified may be comprised in visited SMF updated data. For example, the visited SMF updated data may be same as the VsmfUpdatedData as described in 3GPP TS 29.502 V18.1.0.

In an embodiment, the information of at least one QoS flow may failed to be added/modified be comprised in a QoS flows visited SMF rejected addition modification list, e.g., qosFlowsVsmfRejectedAddModList. For example, the qosFlowsVsmfRejectedAddModList may be present from the second SMF such as V-SMF to the first SMF such as H-SMF. When present, this qosFlowsVsmfRejectedAddModList may include the QoS flows failed to be established or modified because the second SMF such as V-SMF rejected the establishment or modification.

When updating accordingly the QoS rules and QoS Flow level QoS parameters for the failed QoS flow(s) in the terminal device, the first SMF such as H-SMF should exclude the second SMF such as V-SMF rejected QoS flow(s). If all failed QoS flow(s) are due to V-SMF rejection, the update (such as N1 update) to the UE can be skipped.

In an embodiment, the second message may further comprise a QoS flows failed to addition modification list comprising one or more QoS flows failed to be established or modified. For example, the QoS flows failed to addition modification list may be same as the qosFlowsFailedtoAddModList as described in 3GPP TS 29.502 V18.1.0.

In an embodiment, the first message may be sent and the second message may be received a UE or network requested PDU session modification for home-routed roaming scenario e.g. as described in clause 4.3.3.3 of 3GPP TS 23.502 V18.0.0, clause 5.2.2.8.2.2 of 3GPP TS 29.502 V18.1.0, or clause 5.2.2.8.3.2 of 3GPP TS 29.502 V18.1.0.

FIG. 5d shows a flowchart of a method according to another embodiment of the present disclosure, which may be performed by an apparatus implemented in or at or as a first session management function (SMF) or communicatively coupled to the first SMF. As such, the apparatus may provide means or modules for accomplishing various parts of the method 530 as well as means or modules for accomplishing other processes in conjunction with other components. For some parts which have been described in the above embodiments, the description thereof is omitted here for brevity.

At block 532, the first SMF may skip updating the at least one QoS flow failed to be added/modified to the terminal device.

For example, when the first SMF receives the second message comprising information of at least one QoS flow failed to be added/modified indicating that updating the at least one QoS flow failed to be added/modified to a terminal device is not needed and/or the at least one QoS flow failed to be added/modified is rejected by the second SMF, the first SMF may skip updating the at least one QoS flow failed to be added/modified to the terminal device.

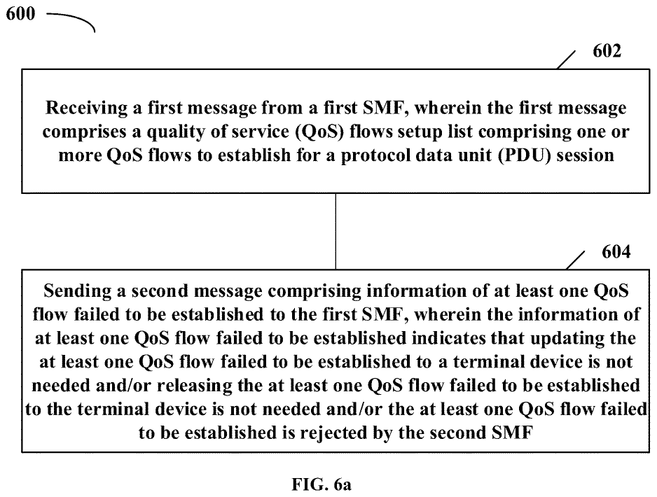

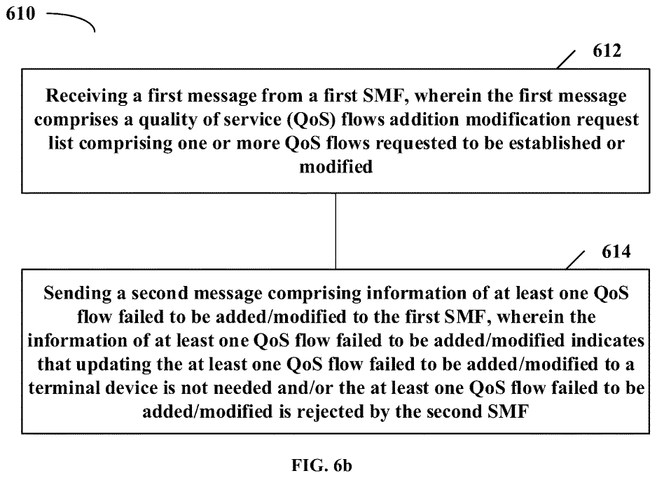

FIG. 6a shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, the second SMF may receive a first message from a first SMF. The first message may comprise a quality of service (QoS) flows setup list comprising one or more QoS flows to establish for a protocol data unit (PDU) session.

At block 604, the second SMF may send a second message comprising information of at least one QoS flow failed to be established to the first SMF. The information of at least one QoS flow failed to be established indicates that updating the at least one QoS flow failed to be established to a terminal device is not needed and/or releasing the at least one QoS flow failed to be established to the terminal device is not needed and/or the at least one QoS flow failed to be established is rejected by the second SMF.

In an embodiment, the first message may comprise a PDU session create response and the second message comprises a PDU session update request.

In an embodiment, the information of at least one QoS flow failed to be established may be comprised in home SMF update data.

In an embodiment, the information of at least one QoS flow failed to be established may be comprised in a QoS flows visited SMF rejected list.

In an embodiment, the information of at least one QoS flow failed to be established may be comprised in a list of QoS flows not needed for releasing to the terminal device.

In an embodiment, the information of at least one QoS flow failed to be established may indicate which QoS flow(s) in a QoS flows release notify list is rejected by the second SMF and/or not needed for releasing to the terminal device.

In an embodiment, the second message may further comprise a QoS flows release notify list comprising one or more QoS flows that have been released or rejected.

In an embodiment, the first message may be received and the second message may be sent during a user equipment (UE) requested PDU session establishment for home-routed roaming scenario.

In an embodiment, the second SMF may be a visited SMF and the first SMF may be a home SMF.

FIG. 6b shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 610 as well as means or modules for accomplishing other processes in conjunction with other components. For some parts which have been described in the above embodiments, the description thereof is omitted here for brevity.

At block 612, the second SMF may receive a first message from a first SMF. The first message comprises a quality of service (QoS) flows addition modification request list comprising one or more QoS flows requested to be established or modified.

At block 614, the second SMF may send a second message comprising information of at least one QoS flow failed to be added/modified to the first SMF. The information of at least one QoS flow failed to be added/modified indicates that updating the at least one QoS flow failed to be added/modified to a terminal device is not needed and/or the at least one QoS flow failed to be added/modified is rejected by the second SMF.

In an embodiment, the first message may comprise a protocol data unit (PDU) session update request and the second message comprises a PDU session update response.

In an embodiment, the information of at least one QoS flow failed to be added/modified may be comprised in visited SMF updated data.

In an embodiment, the information of at least one QoS flow failed to be added/modified may be comprised in a QoS flows visited SMF rejected addition modification list.

In an embodiment, the information of at least one QoS flow failed to be added/modified may be comprised in a list of QoS flows which are failed to be added/modified and not need for updating to the terminal device.

In an embodiment, the information of at least one QoS flow failed to be added/modified may indicate which QoS flow(s) in a QoS flows failed to addition modification list is rejected by the second SMF or not needed for updating to the terminal device.

In an embodiment, the second message may further comprise a QoS flows failed to addition modification list comprising one or more QoS flows failed to be established or modified.

In an embodiment, the first message may be received and the second message may be sent during a user equipment (UE) requested PDU session establishment for home-routed roaming scenario.

In an embodiment, the second SMF may be a visited SMF and the first SMF may be a home SMF.

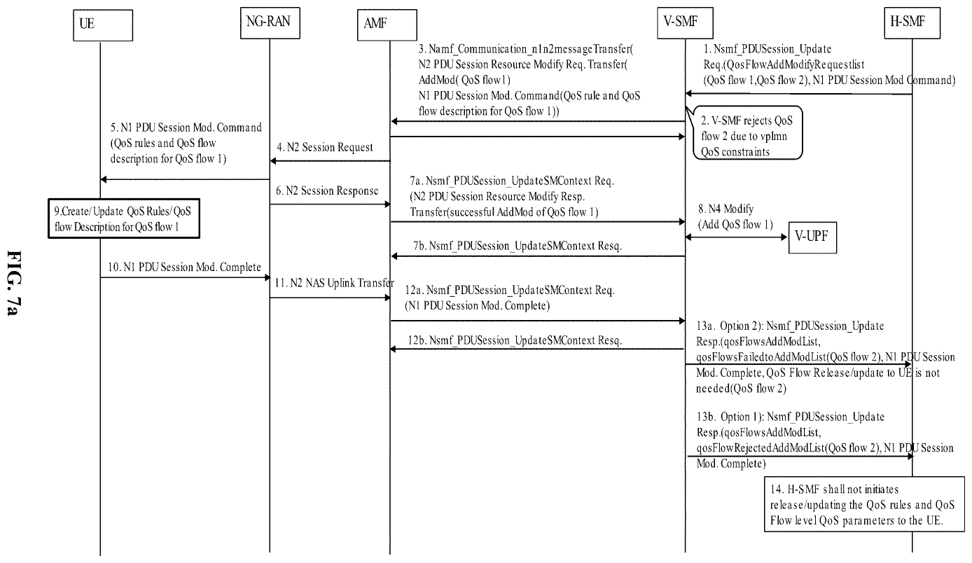

FIG. 7a shows a flowchart of at least one QoS flow addition/modification in PDU session modification according to another embodiment of the present disclosure.

Step 1. H-SMF sends an Nsmf PDUSession_Update Request (QosFlowAddModifyRequestlist (QoS flow 1, QoS flow 2), N1 PDU session modification Command) to V-SMF.

Step 2. V-SMF rejects a QoS flow 2 e.g. due to VPLMN QoS constraints.

Step 3. V-SMF sends an Namf_Communication_nln2messageTransfer (N2 PDU Session Resource Modify Request Transfer (addition/modification QoS flow1), N1 PDU session modification Command (QoS rule and QoS flow description for QoS flow 1)) to AMF and receives a response from AMF.

Step 4. AMF sends an N2 Session Request to NG-RAN.

Step 5. NG-RAN sends an N1 PDU session modification Command (QoS rules and QoS flow description for QoS flow 1) to UE.

Step 6. NG-RAN sends an N2 Session Response to AMF.

Step 7a. AMF sends an Nsmf_PDUSession_UpdateSMContext Request (N2 PDU Session Resource Modify Response Transfer (successful addition/modification QoS flow 1) to V-SMF.

Step 7b. V-SMF sends an Nsmf_PDUSession_UpdateSMContext Response to AMF.

Step 8. V-SMF sends an N4 Modify (Add QoS flow 1) to V-UPF.

Step 9. UE may create/update QoS Rules/QoS flow description for QoS flow 1.

Step 10. UE sends an N1 PDU session modification Complete to NG-RAN.

Step 11. NG-RAN sends an N2 sends an N2 NAS UPlink Transfer to AMF.

Step 12a. AMF sends an Nsmf_PDUSession_UpdateSMContext Request (N1 PDU session modification Complete) to V-SMF.

Step 12b. V-SMF sends an Nsmf_PDUSession_UpdateSMContext Response to AMF.

When sending qosFlowsFailedtoAddModList to H-SMF in Nsmf_PDUSession_Update Response, V-SMF shall inform H-SMF that updating QoS rule/QoS flow Description to UE is not needed for the failed QoS flow with an additional indication for the QoS flow. Alternatively, V-SMF may use a new IE to inform H-SMF of the QoS flow rejected by V-SMF.

Step 13a. Option 2: V-SMF sends an Nsmf_PDUSession_Update Response (qosFlowsAddModList, qosFlowsFailedtoAddModList (QoS flow 2), N1 PDU session modification Complete, QoS Flow Release/update to UE is not needed (QoS flow 2)) to H-SMF.

Step 13b. Option 1: V-SMF sends an Nsmf_PDUSession_Update Response (qosFlowsAddModList, qosFlowRejectedAddModList (QoS flow 2), N1 PDU session modification Complete) to H-SMF.

Step 14. H-SMF shall not initiates release/updating the QoS rules and QoS Flow level QoS parameters to the UE.

When QoS flow Addition/modification initiated by H-SMF (Step 1), if a sub-set of QoS flow is rejected by V-SMF (Step 2). V-SMF continue to send a request to RAN/UE to Add/Modify other QoS flows (Step 3-12), and then V-SMF reports QoS flow failure to H-SMF (Step 13a or 13b).

When sending qosFlowsFailedtoAddModList to H-SMF, V-SMF may inform H-SMF that updating QoS rule/QoS flow Description to UE is not needed. There are two solution options for V-SMF to inform H-SMF.

Option 1: it introduces a new qosFlowRejectedAddModList to distinguish the rejected QoS flow(s) and the failed QoS flow(s). The first SMF such as H-SMF will not trigger NAS update to UE if the rejected QoS flow(s) is received. For example, the rejected QoS flow(s) may be the QoS flow(s) rejected by the second SMF such as V-SMF and may be included in the qosFlowRejectedAddModList. The failed QoS flow(s) may be the QoS flow(s) rejected by the second SMF such as V-SMF and/or RAN and may be included in the qosFlowFailedtoAddModList.

Option 2: it introduces a new indication that update to UE is not required for a QoS flow in the qosFlowFailedtoAddModList, for example, the QoS flow may be the QoS flow rejected by the second SMF such as V-SMF. The new indication may indicate which QoS flow(s) in the qosFlowFailedtoAddModList is rejected by the second SMF such as V-SMF.

After receiving the information, H-SMF shall not initiate updating/release QoS rule/QoS flow description to UE for QoS flow(s) rejected by the V-SMF.

Some messages of FIG. 7a may be same as the corresponding messages as described in various 3GPP specifications such as 3GPP TS 29.502 V18.1.0, 3GPP TS 23.502 V18.0.0, etc. Some messages and operations (such as steps 13a, 13b and 14) of FIG. 7a may be enhanced by the embodiments of the present disclosure.

FIG. 7b shows a flowchart of at least one QoS flows setup in PDU session setup procedure according to another embodiment of the present disclosure.

Step 1. UE sends an N1 PDU session establishment Request to AMF via NG-RAN.

Step 2. AMF sends an Nsmf_PDUSession_CreateSMContext Request to V-SMF and receives a response from V-SMF.

Step 3. V-SMF sends an Nsmf_PDUSession Request to H-SMF.

Step 4. H-SMF sends an Nsmf_PDUSession_Create Response (QosFlowsSetuplist (QoS flow 1, QoS flow 2, QoS flow 3), N1 PDU session establishment Accept) to V-SMF.

Step 5. V-SMF rejects a QoS flow 2 e.g. due to VPLMN QoS constraints

Step 6. V-SMF sends an Namf_Communication_nln2messageTransfer (N2 PDU Session Resource Setup Request Transfer (Add/Modify QoS flow1, 3), N1 PDU session establishment Accept (QoS rule and QoS flow description for QoS flows 1,3)) to AMF and receive a response from AMF.

Step 7. AMF sends an N2 Session Request to NG-RAN.

Step 8. NG-RAN sends an N1 PDU session establishment Accept (QoS rules and QoS flow description for QoS flows 1, 3) to UE.

Step 9. UE creates QoS Rules/QoS flow Description for QoS flows 1, 3.

Step 10. NG-RAN sends an N2 Session Response to AMF.

Step 11a. AMF sends an Nsmf_PDUSession_UpdateSMContext Request (N2 PDU Session Resource Setup Response Transfer (successful addition/modification QoS flows 1, 3) to V-SMF.

Step 11b. V-SMF sends an Nsmf_PDUSession_UpdateSMContext Response to AMF.

Step 12. V-SMF sends an N4 Modify (Add QoS flows 1,3) to V-UPF.

When sending qosFlowsRelNotifyList to H-SMF in Nsmf_PDUSession_Update request, V-SMF shall inform H-SMF that releasing QoS rule/QoS flow Description to UE is not needed for the QoS flow with an additional indication for the QoS flow. Alternatively, V-SMF may use a new IE to inform H-SMF of the QoS flow rejected by V-SMF. There are two solution options for V-SMF to inform H-SMF.

Option 3: it introduces a new qosFlowsVsmfRejectedList to include the QoS flows rejected by the second SMF such as V-SMF. The first SMF such as H-SMF will not trigger NAS update to UE if the qosFlowsVsmfRejectedList is received.

Option 4: it introduces a new indication that update to UE is not required for a QoS flow in the qosFlowsRelNotifyList, for example, the QoS flow may be the QoS flow rejected by the second SMF such as V-SMF. The new indication may indicate which QoS flow(s) in the qosFlowsRelNotifyList is rejected by the second SMF such as V-SMF.

Step 13a. Option 4: V-SMF sends an Nsmf PDUSession_Update Req. (qosFlowsRelNotifyList (QoS flow 2), QoS Flow Release to UE is not needed (QoS flow 2)) to H-SMF.

Step 13b. Option 3: V-SMF sends an Nsmf_PDUSession_Update Req. (qosFlowsRelNotifyList (QoS flow 2), qosFlowsVsmfRejectedList (QoS flow 2)) to H-SMF.

Step 14. H-SMF shall not initiates release the QoS rules and QoS flow level QoS parameters to the UE for QoS flow2.

Step 15. H-SMF sends an Nsmf_PDUSession_Update Response to V-SMF.

Some messages of FIG. 7b may be same as the corresponding messages as described in various 3GPP specifications such as 3GPP TS 29.502 V18.1.0, 3GPP TS 23.502 V18.0.0, etc. Some messages and operations (such as steps 13a, 13b and 14) of FIG. 7b may be enhanced by the embodiments of the present disclosure.

The solution of the embodiments of the present disclosure can be extended to other scenarios when V-SMF determines that updating QoS rule/QoS flow description to UE is not needed.

In an embodiment, in the case that V-SMF rejects a subset of QoS flow addition/modification and setup and other case when V-SMF determine that updating QoS rule/QoS flow description to UE is not needed. When sending a response or initiating QoS release to H-SMF, V-SMF shall inform H-SMF that updating/release QoS rule/QoS flow description to UE is not needed for the failed/rejected QoS flows. After receiving this additional information, H-SMF shall not initiate updating/release QoS rule/QoS flow description to UE for the failed/rejected QoS flows.

In an embodiment, it may add new IEs to indicate the rejected QoS flows by V-SMF to H-SMF.

In an embodiment, when V-SMF rejects a subset of QoS flow addition/modification and other case when V-SMF determine that it is not needed to update QoS rule/QoS flow Description to UE, V-SMF uses additional data to inform H-SMF the updating QoS rule/QoS flow description to UE is not needed for a QoS flow rejected by V-SMF.

In an embodiment, clause 5.2.2.8.2.2 of 3GPP TS 29.502 V18.1.0 may be amended as following.

5.2.2.8.2.2 UE or network (e.g. AMF, V-SMF, I-SMF) requested PDU session modification

The requirements specified in clause 5.2.2.8.2.1 shall apply with the following modifications.

1. Same as step 1 of FIG. 5.2.2.8.2-1, with the following modifications.

The POST request shall contain:
the requestIndication set to UE_REQ_PDU_SES_MOD, and the modifications requested by the UE, e.g. UE requested QoS rules or UE requested Qos flow descriptions, in an N1 SM container IE as specified in clause 5.2.3.1, or indication that the PDU session is allowed to be upgraded to a MA PDU session as specified in clause 6.4.2.2 of 3GPP TS 24.501 [7], for a UE requested PDU session modification; or
the requestIndication set to NW_REQ_PDU_SES_MOD, and the modifications requested by the visited network or the notifications initiated by the visited network, for a visited network requested PDU session modification, e.g. to:
report the release of QoS flow(s) or notify QoS flow(s) whose targets QoS are no longer fulfilled; in the former case, the V-SMF may also include the gosFlowsVsmfRejectedAddModList IE with the QoS flows that are rejected by the V-SMF; in the latter case, the V-SMF/I-SMF may also report an alternative QoS profile which the NG-RAN can currently fulfil in the currentQosProfileIndex IE or report that the NG-RAN cannot even fulfil the lowest alternative QoS profile by setting the nullQoSProfileIndex IE to “true” for the corresponding Qos flow(s);
report that the user plane security enforcement with a value Preferred is not fulfilled or is fulfilled again, in the NotifyList IE and the securityResult IE, if the new security status is received from NG-RAN;
report that access type of the PDU session can be changed; in this case, the anTypeCanBeChanged attribute shall be set to “true”;
report the “MO Exception Data Counter”;
request for QoS modification initiated by VPLMN, if the H-SMF supports the VPLMN QoS (VQoS) feature.

If the update is performed to transfer the PDU Session from non-3gpp access to 3gpp access by setting the attribute anTypeCanBeChanged to “true”, the SMF may perform Network Slice Admission Control before the PDU Session is moved to 3GPP access (i,e, before N3/N9 tunnel for the PDU Session is established).

In an embodiment, clause 5.2.2.8.3.2 of 3GPP TS 29.502 V18.1.0 may be amended as following.

5.2.2.8.3.2 Network (e.g. H-SMF, SMF) requested PDU session modification

The requirements specified in clause 5.2.2.8.3.1 shall apply with the following modifications.

1. Same as step 1 of FIG. 5.2.2.8.3.1-1, with the following modifications.

The requestIndication shall be set to NW_REQ_PDU_SES_MOD.

As part of the modification instructions, the NF Service Consumer may request to modify QoS parameters applicable at the PDU session level (e.g. modify the authorized Session AMBR values) or at the QoS flow level (e.g. modify the MFBR of a particular QoS flow).

The NF Service Consumer may request to establish, modify and/or release QoS flows by including the qosFlowsAddModRequestList IE and/or the qosFlowsRelRequestList IE in the payload body.

The H-SMF or SMF may provide alternative QoS profiles for each GBR QoS flow with Notification control enabled, to allow the NG-RAN to accept the setup of the QoS flow if the requested QoS parameters or at least one of the alternative QoS parameters sets can be fulfilled at the time of setup. If the H-SMF or SMF provides a new list of alternative QoS profile(s) for a given GBR Qos flow, the V-SMF or I-SMF shall replace any previously stored list for this Qos flow with it.

The NF Service Consumer may include epsBearerInfo IE(s), if the PDU session may be moved to EPS during its lifetime and the EPS Bearer(s) information has changed (e.g. a new EBI has been assigned or the mapped EPS bearer QoS for an existing EBI has changed).

The NF Service Consumer may include the modifiedEbiList IE if the PDU session modification procedure resulted in the change of ARP for a QoS flow that has already been allocated an EBI.

The NF Service Consumer may include the revokeEbiList IE to request the V-SMF or I-SMF to release some EBI(s) and delete any corresponding EPS bearer context stored in the V-SMF or I-SMF. The V-SMF or I-SMF shall disassociate the EBI(s) with the QFI(s) with which they are associated.

2. Same as step 2 of FIG. 5.2.2.8.3.1-1, with the following modifications.

The V-SMF or I-SMF may accept all or only a subset of the QoS flows requested to be created or modified within the request.

The list of QoS flows which have been successfully setup or modified, and those which failed or rejected to be so, if any, shall be included in the gosFlowsAddModList IE and/or the gosFlowsFailedtoAddModList IE respectively. The V-SMF may also include the gosFlowsVsmfRejectedAddModList IE with the OoS flows that are rejected by the V-SMF.

The V-SMF or I-SMF may report an alternative QoS profile which the NG-RAN currently fulfils in the currentQosProfileIndex IE of the corresponding Qos flow in the qosFlowsAddModList IE, or report that the NG-RAN cannot even fulfil the lowest alternative Qos profile by setting the nullQoSProfileIndex IE to “true” for the corresponding Qos flow in the qosFlowsAddModList IE.

If the NG-RAN rejects the establishment of a voice QoS flow due to EPS Fallback for IMS voice (see clause 4.13 of 3GPP TS 23.502 [3]), the V-SMF or I-SMF shall return the cause indicating that “mobility due to EPS fallback for IMS voice is on-going” for the corresponding flow in the qosFlowsFailedtoAddModList IE.

The list of QoS flows which have been successfully released, and those which failed to be so, if any, shall be included in the qosFlowsRelList and/or gosFlowsFailedtoRelList IE respectively.

For a QoS flow which failed to be modified, the V-SMF or I-SMF shall fall back to the configuration of the QoS flow as it was configured prior to the reception of the PDU session update request from the NF Service Consumer.

The V-SMF or I-SMF shall store any EPS bearer information received from the H-SMF or SMF. If the revokeEbiList IE is present in the request, the V-SMF or I-SMF shall request delete the corresponding EPS bearer contexts and request the AMF to release the EBIs listed in this IE. If the modifiedEbiList IE is present in the request, the V-SMF or I-SMF shall request the AMF to update the mapping of EBI and ARP.

If the request received from the H-SMF or SMF contains the alwaysOnGranted attribute set to true, the V-SMF or I-SMF shall check and determine whether the PDU session can be established as an always-on PDU session based on local policy.

In an embodiment, Table 6.1.6.2.11-1 of 3GPP TS 29.502 V18.1.0 may add the following underlined content.

TABLE 6.1.6.2.11-1
Definition of type HsmfUpdateData

| | | | | | |
|---|---|---|---|---|---|
| Attribute name | Data type | P | Cardinality | Description | Applicability |

| | | | | |
|---|---|---|---|---|
| qosFlowsRelNotifyList | array(QosFlowItem) | C | 1 . . . N | This IE shall be present if QoS |
| | | | | flows have been released |
| | | | | by RAN or rejected by |
| | | | | the V-SMF. |
| qosFlowsVsmfRejectedList | array(QosFlowItem) | O | 1 . . . N | This IE may be present from |
| | | | | V-SMF to H-SMF when |
| | | | | qosFlowsRelNotifyList |
| | | | | is present. |
| | | | | When present, this IE shall |
| | | | | include the QoS flows |
| | | | | rejected by the V-SMF. |
| | | | | When updating accordingly |
| | | | | the QoS rules and QoS Flow |
| | | | | level QoS parameters for |
| | | | | the released QoS Flow(s) in |
| | | | | the UE, the H-SMF should |
| | | | | exclude the V-SMF rejected |
| | | | | QoS flow(s). If all released |
| | | | | QoS flow(s) are due to V-SMF |
| | | | | rejection, the N1 update to |
| | | | | the UE can be skipped. |

In an embodiment, Table 6.1.6.2.16-1 of 3GPP TS 29.502 V18.1.0 may add the following underlined content.

TABLE 6.1.6.2.16-1
Definition of type VsmfUpdatedData

| | | | | | |
|---|---|---|---|---|---|
| Attribute name | Data type | P | Cardinality | Description | Applicability |

| | | | | |
|---|---|---|---|---|
| qosFlowsFailedtoAddModList | array(QosFlowItem) | C | 1 . . . N | This IE shall be present if QoS flows |
| | | | | failed to be established or modified. |
| qosFlowsVsmfRejectedAddModList | array(QosFlowItem) | O | 1 . . . N | This IE may be present from |
| | | | | V-SMF to H-SMF. |
| | | | | When present, this IE shall |
| | | | | include the QoS flows failed |
| | | | | to be established or modified |
| | | | | because the V-SMF rejected |
| | | | | the establishment or modification. |
| | | | | When updating accordingly the |
| | | | | QoS rules and QoS Flow level |
| | | | | QoS parameters for the failed |
| | | | | QoS Flow(s) in the UE, the |
| | | | | H-SMF should exclude the V-SMF |
| | | | | rejected QoS flow(s). If all |
| | | | | failed QoS flow(s) are due |
| | | | | to V-SMF rejection, the N1 |
| | | | | update to the UE can |
| | | | | be skipped. |

In an embodiment, A.2 of 3GPP TS 29.502 V18.1.0 may add the following underlined content.

A.2 Nsmf PDUSession API

```
openapi: 3.0.0
info:
  version: ‘1.3.0-alpha.2’
  title: ‘Nsmf_PDUSession’
  description: |
    SMF PDU Session Service.
    © 2022, 3GPP Organizational Partners (ARIB, ATIS, CCSA, ETSI, TSDSI, TTA, TTC).
    All rights reserved.
********************** Text Skipped for Clarity *****************
    HsmfUpdateData:
      description: Data within Update Request towards H-SMF, or from I-SMF to SMF
      type: object
      properties:
        requestIndication:
          $ref: #/components/schemas/RequestIndication’
        pci:
          $ref: ‘TS29571_CommonData.yaml#/components/schemas/Pci’
        vcnTunnelInfo:
          $ref: ‘#/components/schemas/TunnelInfo’
        icnTunnelInfo:
          $ref: ‘#/components/schemas/TunnelInfo’
        additionalCnTunnelInfo:
          $ref: ‘#/components/schemas/TunnelInfo’
        servingNetwork:
          $ref: ‘TS29571_CommonData.yaml#/components/schemas/PlmnIdNid’
        anType:
          $ref: ‘TS29571_CommonData.yaml#/components/schemas/AccessType’
        additionalAnType:
          $ref: ‘TS29571_CommonData.yaml#/components/schemas/AccessType’
        ratType:
          $ref: ‘TS29571_CommonData.yaml#/components/schemas/RatType’
        ueLocation:
          $ref: ‘TS29571_CommonData.yaml#/components/schemas/UserLocation’
        ueTimeZone:
          $ref: ‘TS29571_CommonData.yaml#/components/schemas/TimeZone’
        addUeLocation:
          $ref: ‘TS29571_CommonData.yaml#/components/schemas/UserLocation’
        pauseCharging:
          type: boolean
        pti:
          $ref: ‘#/components/schemas/ProcedureTransactionId’
        n1SmInfoFromUe:
          $ref: ‘TS29571_CommonData.yaml#/components/schemas/RefToBinaryData’
        unknownN1SmInfo:
          $ref: ‘TS29571_CommonData.yaml#/components/schemas/RefToBinaryData’
        qosFlowsRelNotifyList:
          type: array
          items:
            $ref: ‘#/components/schemas/QosFlowItem’
          minItems: 1
        qosFlowsVsmfRejectedList:
          type: array
          items:
            $ref: ‘#/components/schemas/QosFlowItem’
          minItems: 1
        qosFlowsNotifyList:
          type: array
          items:
            $ref: #/components/schemas/QosFlowNotifyItem’
          minItems: 1
        NotifyList:
          type: array
          items:
            $ref: ‘#/components/schemas/PduSessionNotifyItem’
          minItems: 1
# The attribute name does not follow the naming conventions specified in 3GPP TS 29.501. The attribute name is kept though as defined in the
current specification for backward compatibility reason.
        epsBearerId:
          type: array
          items:
            $ref: ‘#/components/schemas/EpsBearerId’
          minItems: 0
        hoPreparationIndication:
          type: boolean
        revokeEbiList:
          type: array
          items:
            $ref: #/components/schemas/EpsBearerId’
          minItems: 1
        cause:
          $ref: ‘#/components/schemas/Cause’
        ngApCause:
          $ref: ‘TS29571_CommonData.yaml#/components/schemas/NgApCause’
        5gMmCause Value:
          $ref: ‘TS29571_CommonData.yaml#/components/schemas/5GMmCause’
        alwaysOnRequested:
          type: boolean
          default: false
        cpsInterworkingInd:
          $ref: ‘#/components/schemas/EpsInterworkingIndication’
        secondaryRatUsageReport:
          type: array
          items:
            $ref: ‘TS29571_CommonData.yaml#/components/schemas/SecondaryRatUsageReport’
          minItems: 1
        secondaryRatUsageInfo:
          type: array
          items:
            $ref: ‘TS29571_CommonData.yaml#/components/schemas/SecondaryRatUsageInfo’
          minItems: 1
        anTypeCanBeChanged:
          type: boolean
          default: false
        maReleaseInd:
          $ref: ‘#/components/schemas/MaReleaseIndication’
        maNwUpgradeInd:
          type: boolean
          default: false
        maRequestInd:
          type: boolean
          default: false
        unavailableAccessInd:
          $ref: ‘#/components/schemas/UnavailableAccessIndication’
        psaInfo:
          type: array
          items:
            $ref: ‘#/components/schemas/PsaInformation’
          minItems: 1
        ulclBpInfo:
          $ref: ‘#/components/schemas/UlclBpInformation’
        n4Info:
          $ref: ‘#/components/schemas/N4Information’
        n4InfoExt1:
          $ref: ‘#/components/schemas/N4Information’
        n4InfoExt2:
          $ref: ‘#/components/schemas/N4Information’
        presenceInLadn:
          $ref: ‘TS29571_CommonData.yaml#/components/schemas/PresenceState’
        vsmfPduSessionUri:
          $ref: ‘TS29571_CommonData.yaml#/components/schemas/Uri’
        vsmfId:
          $ref: ‘TS29571_CommonData.yaml#/components/schemas/NfInstanceId’
        vSmfServiceInstanceId:
          type: string
        ismfPduSessionUri:
          $ref: ‘TS29571_CommonData.yaml#/components/schemas/Uri’
        ismfId:
          $ref: ‘TS29571_CommonData.yaml#/components/schemas/NfInstanceId’
        iSmfServiceInstanceId:
          type: string
        dlServingPlmnRateCtl:
          type: integer
          minimum: 10
          nullable: true
        dnaiList:
          type: array
          items:
            $ref: ‘TS29571_CommonData.yaml#/components/schemas/Dnai’
          minItems: 1
        supportedFeatures:
          $ref: ‘TS29571_CommonData.yaml#/components/schemas/SupportedFeatures'
        roamingChargingProfile:
          $ref: ‘TS32291_Nchf_ConvergedCharging.yaml#/components/schemas/RoamingChargingProfile’
        moExpDataCounter:
          $ref: ‘TS29571_CommonData.yaml#/components/schemas/MoExpDataCounter’
        vplmnQos:
          $ref: ‘#/components/schemas/VplmnQos’
        securityResult:
          $ref: ‘#/components/schemas/SecurityResult’
        upSecurityInfo:
          $ref: ‘#/components/schemas/UpSecurityInfo’
        amfNfId:
          $ref: ‘TS29571_CommonData.yaml#/components/schemas/NfInstanceId’
        guami:
          $ref: ‘TS29571_CommonData.yaml#/components/schemas/Guami’
        secondaryRatUsageDataReportContainer:
          type: array
          items:
            $ref: ‘#/components/schemas/SecondaryRatUsageDataReportContainer’
          minItems: 1
        smPolicyNotifyInd:
          type: boolean
          enum:
            - true
        pcfUcCallbackInfo:
          $ref: ‘TS29571_CommonData.yaml#/components/schemas/PcfUeCallbackInfo’
        satelliteBackhaulCat:
          $ref: ‘TS29571_CommonData.yaml#/components/schemas/SatelliteBackhaulCategory’
        maxIntegrityProtectedDataRateUl:
          $ref: ‘#/components/schemas/MaxIntegrityProtectedDataRate’
        maxIntegrityProtectedDataRateDl:
          $ref: ‘#/components/schemas/MaxIntegrityProtectedDataRate’
        upCnxState:
          $ref: ‘#/components/schemas/UpCnxState’
      required:
        - requestIndication
********************** Text Skipped for Clarity *****************
    VsmfUpdatedData:
      description: Data within Update Response from V-SMF, or from I-SMF to SMF
      type: object
      properties:
        qosFlowsAddModList:
          type: array
          items:
            $ref: ‘#/components/schemas/QosFlowItem’
          minItems: 1
        qosFlowsRelList:
          type: array
          items:
            $ref: ‘#/components/schemas/QosFlowItem’
          minItems: 1
        qosFlowsFailedtoAddModList:
          type: array
          items:
            $ref: ‘#/components/schemas/QosFlowItem’
          minItems: 1
        qosFlowsVsmfRejectedAddModList:
          type: array
          items:
            $ref: ‘#/components/schemas/QosFlowItem’
          minItems: 1
        qosFlowsFailedtoRelList:
          type: array
          items:
            $ref: ‘#/components/schemas/QosFlowItem’
          minItems: 1
        n1SmInfoFromUe:
          $ref: ‘TS29571_CommonData.yaml#/components/schemas/RefToBinaryData’
        unknownN1SmInfo:
          $ref: ‘TS29571_CommonData.yaml#/components/schemas/RefToBinaryData’
        ueLocation:
          $ref: ‘TS29571_CommonData.yaml#/components/schemas/UserLocation’
        ueTimeZone:
          $ref: ‘TS29571_CommonData.yaml#/components/schemas/TimeZone’
        addUeLocation:
          $ref: ‘TS29571_CommonData.yaml#/components/schemas/UserLocation’
        assignedEbiList:
          type: array
          items:
            $ref: ‘#/components/schemas/EbiArpMapping’
          minItems: 1
        failedToAssignEbiList:
          type: array
          items:
            $ref: ‘TS29571_CommonData.yaml#/components/schemas/Arp’
          minItems: 1
        releasedEbiList:
          type: array
          items:
            $ref: ‘#/components/schemas/EpsBearerId’
          minItems: 1
        secondaryRatUsageReport:
          type: array
          items:
            $ref: ‘TS29571_CommonData.yaml#/components/schemas/SecondaryRatUsageReport’
          minItems: 1
        secondaryRatUsageInfo:
          type: array
          items:
            $ref: ‘TS29571_CommonData.yaml#/components/schemas/SecondaryRatUsageInfo’
          minItems: 1
        n4Info:
          $ref: ‘#/components/schemas/N4Information’
        n4InfoExt1:
          $ref: ‘#/components/schemas/N4Information’
        n4InfoExt2:
          $ref: ‘#/components/schemas/N4Information’
        n4InfoExt3:
          $ref: ‘#/components/schemas/N4Information’
********************** Text Skipped for Clarity *****************
```

Embodiments herein may provide many advantages, of which a non-exhaustive list of examples follows. In some embodiments herein, it can avoid extra procedure which may cause an error report from UE. In some embodiments herein, it can reduce signaling usage between the first network such as HPLMN and the second network such as VPLMN. In some embodiments, the solution can be extended to simplify the handling of other scenarios when V-SMF determines that updating QoS rule/QoS flow description to UE is not needed. In some embodiments herein, it can avoid the first SMF such as H-SMF to perform unnecessary and incorrect N1 update to the UE for the QoS flows rejected by the second SMF such as V-SMF, which can avoid unexpected result and save traffic on air interface. The embodiments herein are not limited to the features and advantages mentioned above. A person skilled in the art will recognize additional features and advantages upon reading the following detailed description.

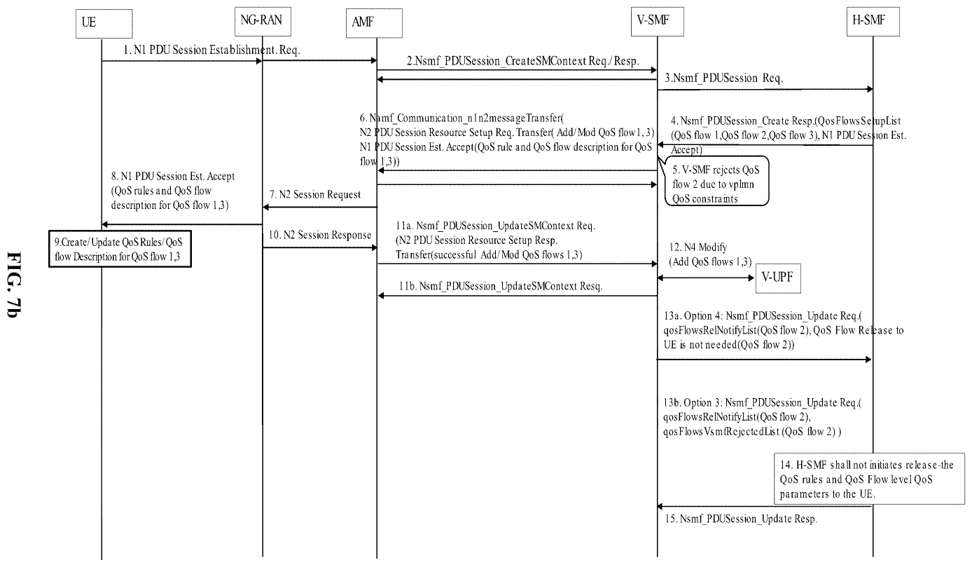

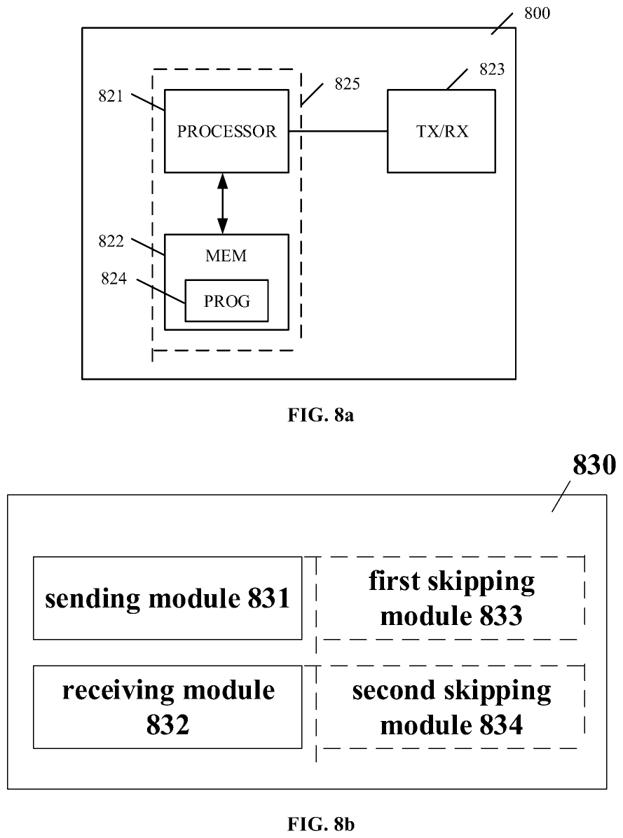

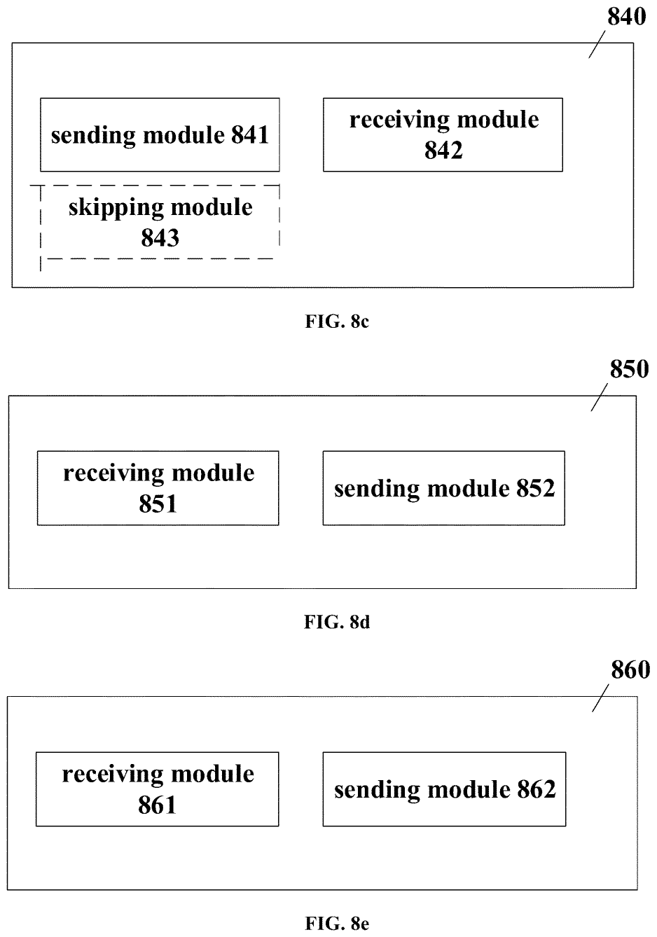

FIG. 8a is a block diagram showing an apparatus suitable for practicing some embodiments of the disclosure. For example, the first SMF or the second SMF described above may be implemented as or through the apparatus 800.

The apparatus 800 comprises at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first SMF, the memory 822 contains instructions executable by the processor 821, whereby the first SMF operates according to any of the methods related to the first SMF as described above.

In an embodiment where the apparatus is implemented as or at the second SMF, the memory 822 contains instructions executable by the processor 821, whereby the second SMF operates according to any of the methods related to the second SMF as described above.

FIG. 8b is a block diagram showing a first SMF according to an embodiment of the disclosure. As shown, the first SMF 830 comprises a sending module 831 configured to send a first message to a second SMF. The first message may comprise a QoS flows setup list comprising one or more QoS flows to establish for a protocol data unit (PDU) session. The first SMF 830 further comprises a receiving module 832 configured to receive a second message comprising information of at least one QoS flow failed to be established from the second SMF. The information of at least one QoS flow failed to be established indicates that updating the at least one QoS flow failed to be established to a terminal device is not needed and/or releasing the at least one QoS flow failed to be established to the terminal device is not needed and/or the at least one QoS flow failed to be established is rejected by the second SMF.

In an embodiment, the first SMF 830 further comprises a first skipping module 833 configured to skip updating the at least one QoS flow failed to be established to the terminal device.

In an embodiment, the first SMF 830 further comprises a second skipping module 834 configured to skip releasing the at least one QoS flow failed to be established to the terminal device.

FIG. 8c is a block diagram showing a first SMF according to another embodiment of the disclosure. As shown, the first SMF 840 comprises a sending module 841 configured to send a first message to a second SMF. The first message may comprise a quality of service (QoS) flows addition modification request list comprising one or more QoS flows requested to be established or modified. The first SMF 840 further comprises a receiving module 842 configured to receive a second message comprising information of at least one QoS flow failed to be added/modified from the second SMF. The information of at least one QoS flow failed to be added/modified indicates that updating the at least one QoS flow failed to be added/modified to a terminal device is not needed and/or the at least one QoS flow failed to be added/modified is rejected by the second SMF.

In an embodiment, the first SMF 840 further comprises a skipping module 843 configured to skip updating the at least one QoS flow failed to be added/modified to the terminal device.

FIG. 8d is a block diagram showing a second SMF according to an embodiment of the disclosure. As shown, the second SMF 850 comprises a receiving module 851 configured to receive a first message from a first SMF. The first message may comprise a QoS flows setup list comprising one or more QoS flows to establish for a PDU session. The second SMF 850 further comprises a sending module 852 configured to send a second message comprising information of at least one QoS flow failed to be established to the first SMF. The information of at least one QoS flow failed to be established indicates that updating the at least one QoS flow failed to be established to a terminal device is not needed and/or releasing the at least one QoS flow failed to be established to the terminal device is not needed and/or the at least one QoS flow failed to be established is rejected by the second SMF.

FIG. 8e is a block diagram showing a second SMF according to another embodiment of the disclosure. As shown, the second SMF 860 comprises a receiving module 861 configured to receive a first message from a first SMF. The first message may comprise a quality of service (QoS) flows addition modification request list comprising one or more QoS flows requested to be established or modified. The second SMF 860 further comprises a sending module 862 configured to send a second message comprising information of at least one QoS flow failed to be added/modified to the first SMF. The information of at least one QoS flow failed to be added/modified indicates that updating the at least one QoS flow failed to be added/modified to a terminal device is not needed and/or the at least one QoS flow failed to be added/modified is rejected by the second SMF.

Further, the exemplary overall commutation system including the terminal device and the network node (such as the first SMF or the second SMF) will be introduced as below.

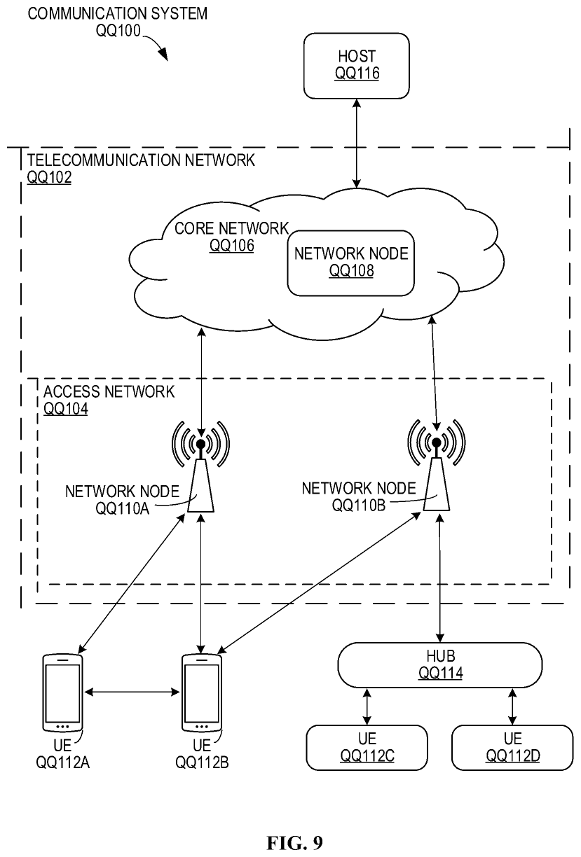

FIG. 9 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

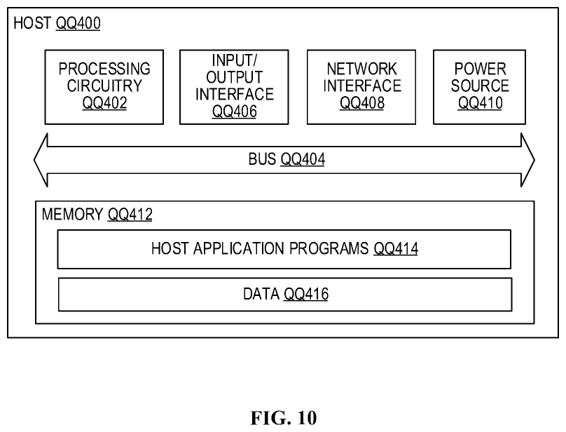

FIG. 10 is a block diagram of a host QQ400, which may be an embodiment of the host QQ116 of FIG. 9, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the terminal devices, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE.

Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

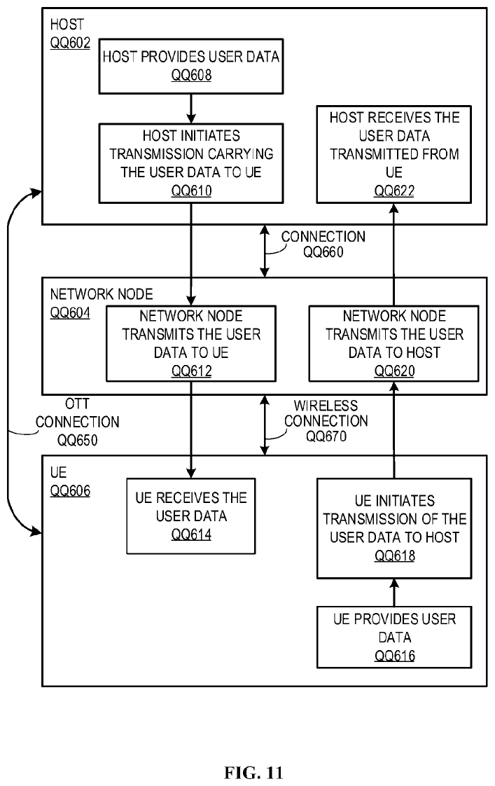

FIG. 11 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 9), network node (such as network node QQ110a of FIG. 9), and host (such as host QQ116 of FIG. 9 and/or host QQ400 of FIG. 10) discussed in the preceding paragraphs will now be described with reference to FIG. 11.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 9) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, in some embodiments herein, it can avoid extra procedure which may cause an error report from UE. In some embodiments herein, it can reduce signaling usage between the first network such as HPLMN and the second network such as VPLMN. In some embodiments, the solution can be extended to simplify the handling of other scenarios when V-SMF determines that updating QoS rule/QoS flow description to UE is not needed. In some embodiments herein, it can avoid the first SMF such as H-SMF to perform unnecessary and incorrect N1 update to the UE for the QoS flows rejected by the second SMF such as V-SMF, which can avoid unexpected result and save traffic on air interface.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve.

There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the operations related to the network node as described above to transmit the user data from the host to the UE.

Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the operations related to the network node as described above to transmit the user data from the host to the UE.

Embodiment 4. The method of the previous embodiment, further comprising, at the network node, transmitting the user data provided by the host for the UE.

Embodiment 5. The method of any of the previous 2 embodiments, wherein the user data is provided at the host by executing a host application that interacts with a client application executing on the UE, the client application being associated with the host application.

Embodiment 6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the operations related to the network node as described above to transmit the user data from the host to the UE.

Embodiment 7. The communication system of the previous embodiment, further comprising:
the network node; and/or
the user equipment.

Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the operations related to the network node as described above to receive the user data from the UE for the host.

Embodiment 10. The host of the previous 2 embodiments, wherein:
the processing circuitry of the host is configured to execute a host application, thereby providing the user data; and
the host application is configured to interact with a client application executing on the UE, the client application being associated with the host application.

Embodiment 11. The host of they of the previous 2 embodiments, wherein the initiating receipt of the user data comprises requesting the user data.

Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the operations related to the network node as described above to receive the user data from the UE for the host.

Embodiment 13. The method of the previous embodiment, further comprising at the network node, transmitting the received user data to the host.

Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the operations related to the UE as described above to receive the user data from the host.

Embodiment 15. The host of the previous embodiment, wherein the cellular network further includes a network node configured to communicate with the UE to transmit the user data to the UE from the host.

Embodiment 16. The host of the previous 2 embodiments, wherein:
the processing circuitry of the host is configured to execute a host application, thereby providing the user data; and
the host application is configured to interact with a client application executing on the UE, the client application being associated with the host application.

Embodiment 17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the operations related to the UE as described above to receive the user data from the host.

Embodiment 18. The method of the previous embodiment, further comprising:
at the host, executing a host application associated with a client application executing on the UE to receive the user data from the UE.

Embodiment 19. The method of the previous embodiment, further comprising:
at the host, transmitting input data to the client application executing on the UE, the input data being provided by executing the host application,
wherein the user data is provided by the client application in response to the input data from the host application.

Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the operations related to the UE as described above to transmit the user data to the host.

Embodiment 21. The host of the previous embodiment, wherein the cellular network further includes a network node configured to communicate with the UE to transmit the user data from the UE to the host.

Embodiment 22. The host of the previous 2 embodiments, wherein:
the processing circuitry of the host is configured to execute a host application,
thereby providing the user data; and
the host application is configured to interact with a client application executing on the UE, the client application being associated with the host application.

Embodiment 23. A method implemented by a host configured to operate in a communication system that further includes a network node and a user equipment (UE), the method comprising:
at the host, receiving user data transmitted to the host via the network node by the UE, wherein the UE performs the operations related to the UE as described above to transmit the user data to the host.

Embodiment 24. The method of the previous embodiment, further comprising:
at the host, executing a host application associated with a client application executing on the UE to receive the user data from the UE.

Embodiment 25. The method of the previous embodiments, further comprising:
at the host, transmitting input data to the client application executing on the UE, the input data being provided by executing the host application,
wherein the user data is provided by the client application in response to the input data from the host application.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the first SMF or the second SMF may not need a fixed processor or memory, any computing resource and storage resource may be arranged from the first SMF or the second SMF in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-40. (canceled)

41. A method performed by a first session management function (SMF) of a communication network, the method comprising:
sending, to a first SMF of the communication network, a first message comprising a quality of service (QoS) flows addition modification request list that indicates one or more QoS flows requested to be established or modified; and
receiving from the second SMF a second message comprising information about at least one QoS flow that failed to be added/modified, wherein the information indicates one or more of the following:
that updating the at least one QoS flow to a terminal device is not needed, and that the at least one QoS flow is rejected by the second SMF.

42. The method according to claim 41, further comprising, based on the second message, skipping updating the at least one QoS flow to the terminal device.

43. The method according to claim 41, wherein the first message comprises a protocol data unit (PDU) session update request and the second message comprises a PDU session update response.

44. The method according to claim 41, wherein the information is included in visited SMF updated data.

45. The method according to claim 41, wherein one or more of the following applies:
the information is included in one of the following: a QoS flows visited SMF rejected addition modification list, or a list of QoS flows which are failed to be added/modified and not need for updating to the terminal device; and
the information indicates one or more of the following: which of the at least one QoS flow was rejected by the second SMF, and which of the at least one QoS flow that updating to the terminal device was not needed.

46. The method according to claim 41, wherein the second message further comprises a QoS flows failed to addition modification list that indicates one or more QoS flows failed to be established or modified.

47. The method according to claim 41, wherein the first message is received and the second message is sent during a protocol data unit (PDU) session establishment for home-routed roaming scenario requested by one of the following: the terminal device, or the communication network.

48. The method according to claim 41, wherein the second SMF is a visited SMF for the terminal device and the first SMF is a home SMF for the terminal device.

49. A method performed by a second session management function (SMF) of a communication network, the method comprising:
receiving, from a first SMF of the communication network, a first message comprising a quality of service (QoS) flows addition modification request list that indicates one or more QoS flows requested to be established or modified; and
sending to the first SMF a second message comprising information about at least one QoS flow that failed to be added/modified, wherein the information indicates one or more of the following:
that updating the at least one QoS flow to a terminal device is not needed, and that the at least one QoS flow is rejected by the second SMF.

50. The method according to claim 49, wherein the first message comprises a protocol data unit (PDU) session update request and the second message comprises a PDU session update response.

51. The method according to claim 49, wherein the information about the at least one QoS flow failed to be added/modified is comprised in visited SMF updated data.

52. The method according to claim 49, wherein one or more of the following applies:
the information is included in one of the following: a QoS flows visited SMF rejected addition modification list, or a list of QoS flows which are failed to be added/modified and not need for updating to the terminal device; and
the information indicates one or more of the following: which of the at least one QoS flow was rejected by the second SMF, and which of the at least one QoS flow that updating to the terminal device was not needed.

53. The method according to claim 49, wherein the second message further comprises a QoS flows failed to addition modification list that indicates one or more QoS flows failed to be established or modified.

54. The method according to claim 49, wherein the first message is received and the second message is sent during a protocol data unit (PDU) session establishment for home-routed roaming scenario requested by one of the following: the terminal device, or the communication network.

55. The method according to claim 49, wherein the second SMF is a visited SMF for the terminal device and the first SMF is a home SMF for the terminal device.

56. A first session management function (SMF) configured to operate in a communication network, the first SMF comprising:
a processor; and
a memory operably coupled to the processor and containing instructions that, when executed by the processor, configure the first SMF to:
send, to a first SMF of the communication network, a first message comprising a quality of service (QoS) flows addition modification request list that indicates one or more QoS flows requested to be established or modified; and
receive from the second SMF a second message comprising information about at least one QoS flow that failed to be added/modified, wherein the information indicates one or more of the following:
that updating the at least one QoS flow to a terminal device is not needed, and
that the at least one QoS flow is rejected by the second SMF.

57. A second session management function (SMF) configured to operate in a communication network, the second SMF comprising:
a processor; and
a memory operably coupled to the processor and containing instructions that, when executed by the processor, configure the second SMF to:
receive, from a first SMF of the communication network, a first message comprising a quality of service (QoS) flows addition modification request list that indicates one or more QoS flows requested to be established or modified; and
send to the first SMF a second message comprising information about at least one QoS flow that failed to be added/modified, wherein the information indicates one or more of the following:
that updating the at least one QoS flow to a terminal device is not needed, and
that the at least one QoS flow is rejected by the second SMF.
